(19) United States
(12) Patent Application Publication
(10) Pub. No.: US 2016/0260293 A1
(43) Pub. Date: Sep. 8, 2016

(54) METHODS AND SYSTEMS FOR PROVIDING STEPWISE SOCIAL LOTTERY GAMES

(71) Applicant: Lottery Management Consulting, LLC, Olympia, WA (US)

(72) Inventor: Stephen Eric Wade, Olympia, WA (US)

(73) Assignee: LOTTERY MANAGEMENT CONSULTING, LLC, Olympia, WA (US)

(21) Appl. No.: 14/637,298

(22) Filed: Mar. 3, 2015

(51) Int. Cl. G07F 17/32; A63F 3/06

(52) U.S. Cl. CPC G07F 17/3262; A63F 3/0645; G07F 17/329

(57) ABSTRACT

Methods and systems providing stepwise social lottery games are disclosed. During play of a stepwise social lottery games, players are provided with up-to-date aggregated player action data, and allowed to take action on their wager items having temporary ticket value during a predetermined period of time. The aggregated player action data may include a total number of wager items redeemed by players.

### BACKGROUND

The present disclosure relates generally to wager-based games and more particularly to lotteries. Governments at all levels recognize that gambling is a human behavior that has the potential for antisocial consequences. Consequently, most governments seek to regulate gambling in some way, either by banning it outright or by limiting the kinds of wagers that can be made. Many governments also recognize that gambling is a potential source of revenue for pro-social causes. The governments thus frequently sanction limited forms of gambling to be administered by themselves, both 1) to provide a regulated and harm-limiting path for the expression of what is evidently a common human behavior, and 2) to provide revenue for the government.

Government-sanctioned gambling enterprises are called lotteries. The most common lottery games of the twentieth century belong to one of the “numbers”, “lotto”, or “instant” classes. In both “numbers” and “lotto” lottery games, the player when placing a wager chooses a subset of numbers from among a prescribed set of numbers, and the lottery at a later time randomly selects a subset of numbers from the same set. Prizes are awarded to players, who match all (or in certain games, some) of the lottery's randomly selected set. In “numbers” games, the lottery's selection is made sequentially, and the order of selection may be a factor in matching. In “lotto” games, the lottery's selection may be made sequentially, but the order of selection is not a factor in matching.

In “instant” games, a predetermined wager outcome is associated with each of a plurality of wager items in a manufacturing process. This manufacturing process may ultimately represent each of these wager items as a printed paper ticket or other physical item, or as a unit record in an encrypted file for an electronic computer system. The player when placing a wager receives one of these wager items, either by taking possession of the physical item or by uniquely accessing the electronic unit record. Lotteries try to make the experience of playing “instant” games entertaining by engaging the player in the process of revealing the outcome. In paper “instant” games, the outcome is usually revealed by the player scratching off an opaque covering that initially hides a pattern of marks that represent the result. In electronic “instant” games, often called “video lottery terminals”, the predetermined outcome may be revealed in an elaborate series of events represented on a video screen.

Governments that offer lotteries typically address the goal of harm minimization by restricting the kinds of wagering that are permissible within the lottery. The wagers offered by lotteries are typically defined within lottery games. An almost universal condition is that wagers may be placed on the future outcomes of events that the person placing the wager (“player”) cannot influence. When this condition appears to be but in fact is not met, as when players wager on the outcome of a sporting contest that has been “fixed” through collusion of the contestants, the goal of harm minimization is not met, and the negative consequences of gambling may contaminate sports.

In order to assure that players cannot influence the outcomes of the events on which they place wagers, governments have typically made the player an entirely passive participant. That is, once the player places a wager by buying a ticket in a lottery game, no action that the player takes can influence the financial outcome of the wager. Governments also typically address the goal of harm minimization by specifying that lottery games shall not be games of skill. This prevents skilled players from exploiting unskilled players in government-organized games. However, as a result of these measures, lotteries have limited their ability to meet their goal of raising revenue for pro-social causes.

### SUMMARY

Implementations of the systems, electronic devices, and methods for providing lottery games that provide aggregate player action data to players, and allow players to redeem their wager items at temporary values are disclosed herein. One implementation is a method including receiving, over a network, wager information for a first plurality of wager items, from a plurality of player computing devices, each wager item having a first predetermined price. The method further includes determining, using a processor, a multiplier from a set of multipliers at a predetermined time. The method further includes updating, using the processor, value of each wager item by applying the multiplier to the first predetermined price. The method further includes transmitting, over the network, updated value of each wager item to the plurality of player computing devices. The method further includes receiving player action data, from at least some of the plurality of player computing devices. The method further includes aggregating the player action data. The method further includes transmitting the aggregate player action data to the plurality of player computing devices.

Another implementation is an electronic device configured to allow a player to play a lottery game. The electronic device includes a display configured to display the lottery game to the player, a user-input device, and one or more data processors and one or more storage devices storing instructions that, when executed by the one or more data processors, cause the one or more data processors to perform operations comprising: receiving, over a network, from a lottery gaming server, information regarding a plurality of wager item types, including a predetermined price for each wager item; displaying in a user interface provided on the display received information regarding the plurality of wager item types; receiving, from the user interface, a request to purchase a wager item of a first wager item type at the predetermined price; transmitting, over the network, to the lottery gaming server, a request to purchase a wager item of a first wager item type at the predetermined price; receiving, over the network, from the lottery gaming server, a first updated price for the wager item and a first price validity period; displaying the first updated price and the first price validity period for the wager item, wherein the player is allowed to redeem the wager item at the first updated price during the validity period; receiving, over the network, from the lottery gaming server, player activity data including a total number of redeemed wager items by a plurality of players at the first updated price; displaying the received player activity data; receiving, over the network, from the lottery gaming server, a second updated price for the wager item and a second price validity period; displaying the second updated price for the wager item and the second price validity period; receiving, over the network, from the lottery gaming server, updated player activity data including a total number of redeemed wager items at the first updated price and a total number of redeemed wager items at the second updated price; and displaying the updated player activity data.

Another implementation is a system comprising: one or more data processors; and one or more storage devices storing instructions that, when executed by the one or more data processors, cause the one or more data processors to perform operations. The operations include receiving wager information for a first wager item, from a first player computing device; determining a first temporary value of the first wager item; transmitting, to the first player computing device, the first temporary value of the first wager item, and action options available to the player prior to a predetermined period of time; receiving player action data from a plurality of additional player computing devices; aggregating the player action data; and transmitting the aggregated player action data to the first player computing device; and receiving a request, from the player computing device, to redeem the first wager item at the first temporary value.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system, in an accordance with a described implementation;

FIGS. 2A-2G illustrate user interfaces of a stepwise social lottery game involving multiple pseudo stocks, in an accordance with a described implementation;

FIG. 3 illustrates a flowchart of a process for providing a stepwise social lottery game to a plurality of player computing devices, and allowing for distribution of player action data during play, in an accordance with a described implementation;

FIG. 4 illustrates is a flowchart of a process for providing a stepwise social lottery game to a player of a player computing device, in an accordance with a described implementation;

FIGS. 5A-B are flow diagrams illustrating exchange of data between the stepwise social lottery management engine and player computing devices during play of a lottery game that allows for sharing of player action data, in accordance with a described implementation;

FIGS. 6A-6E are illustrations of user interfaces allowing a player to play a stepwise social lottery game with winning numbers selected during distinct steps, in accordance with a described implementation;

FIG. 7 illustrates a flowchart of a process for providing a stepwise lottery game that allows for distribution of player action data to the players, in accordance with a described implementation;

FIG. 8 is a flowchart of a process for providing a stepwise lottery game to a player of a player computing device that allows for distribution of player action data, in accordance with a described implementation; and

FIGS. 9A-9B are flow diagrams illustrating exchange of data between a stepwise social lottery management engine and player computing devices during play of a lottery game that allows for sharing of player action data, in accordance with a described implementation.

Like reference numbers and designations in the various drawings indicate like elements.

### DETAILED DESCRIPTION

Numerous specific details may be set forth below to provide a thorough understanding of concepts underlying the described implementations. It may be apparent, however, to one skilled in the art that the described implementations may be practiced without some or all of these specific details. In other instances, some process steps have not been described in detail in order to avoid unnecessarily obscuring the underlying concept.

According to various implementations disclosed herein, stepwise lottery games are provided that allow for players to be in fact active agents influencing the financial outcome of their wager. An electronic data network connecting multiple points of player interaction is provided that offers feedback to one player about what other players are doing. Such information provided to the players during the lottery game supports a social and competitive aspect of play, further enhancing player engagement and revenue generation. As a result, the stepwise social lottery game provides the combination of actual agency and social context.

The new class of lottery games discussed in this disclosure is descriptively called “stepwise social” lottery games. However, these lottery games can be given any other name, and the stepwise social lottery game is provided for illustrative purposes only. In a stepwise social lottery game, a player places a wager by buying a ticket in the game. The value of the ticket may be determined by multiple distinct sequential operations or steps taken by the lottery. After one or more of these steps, and before proceeding to the next step, the lottery communicates to the players the outcomes determined by the steps that have been completed and allows the player to take action with respect to the ticket. The action that the player may take may be to continue holding the ticket, cashing in the ticket, or pooling the ticket with other tickets.

In some embodiments, during the stepwise lottery games, multiple players may have purchased tickets that initially have the same undetermined prize value. As the ticket value determining steps proceed, at least some of the tickets acquire a temporarily determined prize value. This value is stable only during the interval between steps. During this time, the lottery game communicates to the players the temporary value of these tickets and how they may be recognized, and offers to validate (“buy” or “cash”) these tickets at their temporary value. Players holding these tickets now have a choice: to validate the ticket before the next step to be taken by the lottery, or to hold the ticket through the next step and evaluate again.

In some embodiments, during the interval between steps, the stepwise lottery may communicate to players about the choices that other players are making. For example, information about player choices may include any combination of volume of validated tickets by the lottery, volume of cashed tickets, volume of pooled tickets, volume of tickets still held by players, etc. This information advantageously adds a social dimension to the play of stepwise lottery games.

In some embodiments, the sequence, timing, and number of steps that are to be taken by the stepwise lottery game may be defined by the rules of the game. In some embodiments, some of these parameters (i.e., the sequence, timing, and number of steps) may be defined in a probabilistic way (i.e., with ranges rather than point values). For instance, the number of steps may be defined as between five and ten, with corresponding likelihoods. For example, there may be 10% chance that the game will have five steps, 20% chance that the game will have six steps, 30% chance that the game will have eight steps, 20% chance that the game will have nine steps, and 10% chance that the game will have ten steps. This adds a further chance dimension for consideration, as the opportunity for action after (for example) the sixth step may, or may not, be the last such opportunity.

In some embodiments, the stepwise social lottery games discussed herein may be government-sanctioned lotteries, and the collective body of players may be defined by the presence within a government jurisdiction. In other embodiments, the collective body of players in a stepwise social lottery game may be defined by presence within a property or set of properties under the control of some form of enterprise (e.g., a casino, or a group of casinos operating together). In other embodiments, the collective body of players in a stepwise social game may be defined by the players' participation in a networked game, that may be provided over the Internet or a mobile communications network.

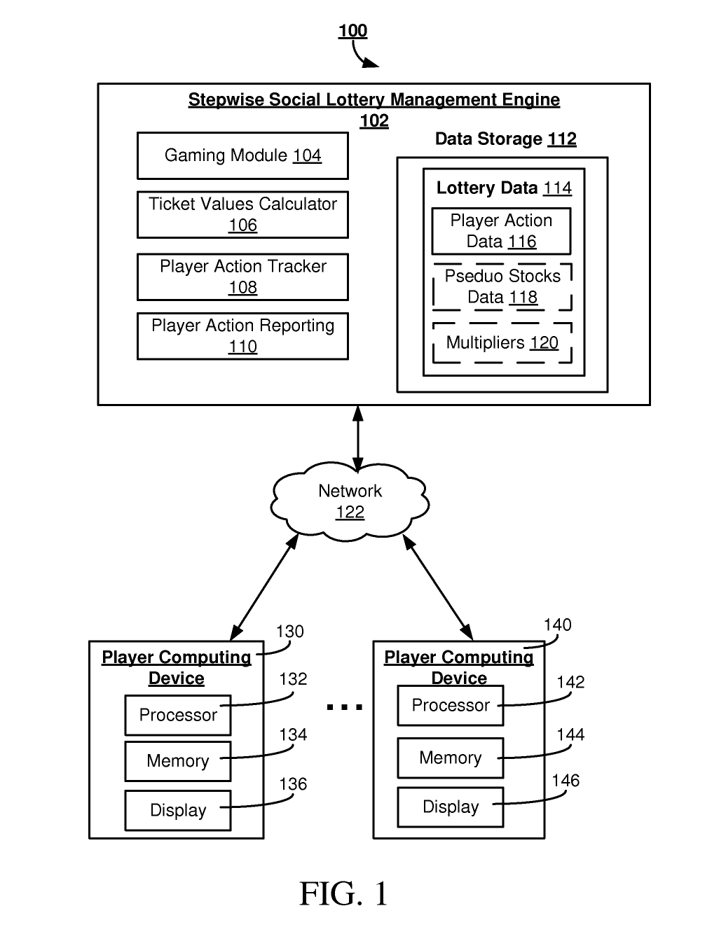

Referring to FIG. 1, a block diagram of a computer system 100 in accordance with a described implementation is shown. The system 100 includes player computing devices 130 through 140, each of which communicate with a stepwise social lottery management engine 102, via a network 122. The computer system 100 may be under control of a lottery game provider (e.g., the Washington State Lottery).

The player computing devices 130 through 140 may execute a web browser or another application (e.g., a lottery video game, a desktop application, a mobile phone application, etc.) to allow players to play a stepwise social lottery game, over the network 122. The player computing devices 130 through 140 may be any number of different types of user electronic devices configured to communicate, via the network 122. The player computing devices may be an electronic gaming machine, a laptop computer, a desktop computer, a tablet computer, a smartphone, a wearable device, a video lottery terminal, a digital video recorder, a set-top box for a television, a video game console, or any combination thereof, etc.).

The player computing device 130 is shown to include a processor 132, a memory 134 (i.e., a processing circuit), and a display 136. The memory 134 may store machine instructions that, when executed by the processor 132 cause the processor 132 to perform one or more of the operations described herein. The processor 132 may include a microprocessor, ASIC, FPGA, etc., or combinations thereof. The memory 134 may include, but is not limited to, electronic, optical, magnetic, or any other storage or transmission device capable of providing the processor 132 with program instructions. The memory 134 may include a floppy disk, CD-ROM, DVD, magnetic disk, memory chip, ROM, RAM, EEPROM, EPROM, flash memory, optical media, or any other suitable memory from which the processor 132 can read instructions. The instructions may include code from any suitable computer programming language such as, but not limited to, C, C++, C#, Java, JavaScript, Perl, HTML, XML, Python and Visual Basic.

The player computing device 130 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.).

The one or more user interface devices may be internal to the housing of the player computing device 130 (e.g., a built-in display, microphone, etc.) or external to the housing of the player computing device 130 (e.g., a monitor connected to player computing device 130, a speaker connected to player computing device 130, etc.), according to various implementations. For example, the player computing device 130 may include the electronic display 136, which displays lottery game related data received from the engine 102. In various implementations, the display 136 may be located inside or outside of the same housing as that of the processor 132 and/or the memory 134. For example, the display 136 may be an external display, such as a computer monitor, television set, or any other stand-alone form of electronic display. In other examples, the display 136 may be integrated into the housing of a laptop computer, a mobile device, or other form of a computing device having an integrated display.

In some embodiments, at least one of the player computing devices (130 through 140) may be an electronic gaming machine (“EGM”) dedicated to offering the stepwise social games (and other games) to players at a casino, a retailer location, or an area dedicated to lottery gaming. The EGM may include any number of user interface devices that convey sensory information to a player and/or receive input from the player. For example, the EGM may include electronic displays, and/or speakers to convey information to the player of the EGM. The EGM may include a console having one or more inputs configured to receive input from a user. For instance, the player may purchase a lottery ticket, select numbers if playing a numbers lottery game, or pseudo stocks for purchase, by manipulating the one or more inputs. In one embodiment, the display of the EGM may also be a touch screen display configured to receive input from a user.

A controller within the gaming device EGM may run one or more lottery games, such as a stepwise social lottery game based on the process 400, 800, or another process described below, in response to receiving input from a user via the inputs, or one or more display(s). For example, the inputs may be operated to purchase a ticket, select numbers, to take action before all the winning numbers are selected, etc.

The EGM may include a main cabinet that provides a secure enclosure that prevents tampering with the machine components, such as a game controller located within the interior of the main cabinet. The main cabinet may include an access mechanism (“a door”) allowing the interior of the EGM to be accessed. Actuation of a door may be controlled by a locking mechanism. In some embodiments, the locking mechanism, the interior of the main cabinet, and the door may be monitored with security sensors of various types to detect whether the interior has been accessed. For instance, a light sensor may be provided within the main cabinet to detect a change in light-levels when the door is opened and/or an accelerometer may be attached to the door to detect when the door is opened.

The computer system 100 includes a stepwise social lottery management engine 102 configured to enable play of a stepwise social lottery game by users of the player computing devices 130 through 140. The stepwise social lottery management engine 102 may be one or more electronic devices connected to the network 122. The stepwise social lottery management engine 102 may be a computer server (e.g., FTP servers, file sharing servers, web servers, etc.) or a combination of servers (e.g., a data center, a cloud computing platform, etc.). The stepwise social lottery management engine 102 may have a processing circuit including a processor (not shown) and a memory that stores program instructions executable by the processor. In cases in which the stepwise social lottery management engine 102 is a combination of computing devices, the processor may represent the collective processors of the devices, and the memory may represent the collective memories of the devices.

As shown in FIG. 1, the stepwise social lottery management engine 102 includes a gaming module 104, which selects winning numbers in distinct steps, while allowing players to take player action with respect to their lottery tickets in between the steps. The stepwise social lottery management engine 102 includes a ticket value calculator module 106, which calculates temporary ticket values for the stepwise social lottery tickets, as well as final ticket values. In some embodiments, after the selection of some of the winning numbers, temporary ticket values may be calculated by the ticket values calculator module 106 based at least in part on the player selected numbers and the already selected winning numbers.

A player action tracker module 108 may receive player action data from player computing devices participating in the stepwise social lottery game. The player action tracker module 108 may process the received player action data by storing it in data storage 118 (e.g., in the player action data 122). The player action tracker module 108 may aggregate the received player action data. For example, the module 108 may calculate the total number of stepwise social lottery tickets that were purchased, the total number of redeemed tickets, the total number of held tickets, and the total number of pooled tickets. As the player action data is continuously received from the player computing devices, the player action tracker 108 updates its records to maintain up to date player activity data. The player action data may be communicated to the player computing devices by a player action reporting module 110. The modules 104, 106 108, and 110 are provided for illustrative purposes, and the stepwise social lottery management engine 102 may have fewer or more modules that implement the functionality of the stepwise social games. For example, the player action tracker 108 and the player action reporting module 110 may be a single module.

To protect privacy of the players, data collection may be limited or anonymized in many implementations. In particular, certain data may be anonymized in one or more ways before it is stored or used, so that personally identifiable information is removed. For example, a player's identity may be anonymized so that no personally identifiable information can be determined for the player, or a player's geographic location may be generalized where location information is obtained (such as to a city, ZIP code, or state level), so that a particular location of a player cannot be determined. The player may have control over how information is collected about him or her and used by stepwise social lottery management engine 102 or another engine or service. The player may be provided with an option for opting out of collection of any player action data, behavior data, or other type of player data.

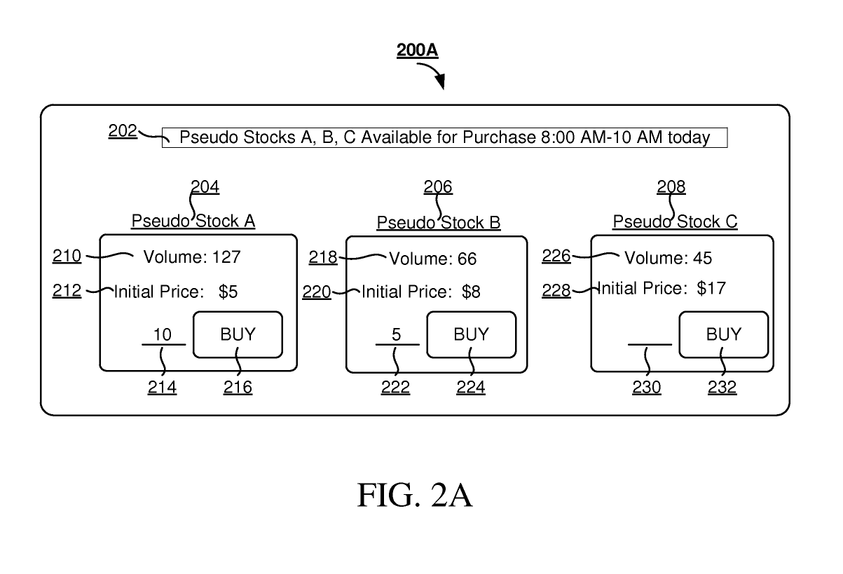

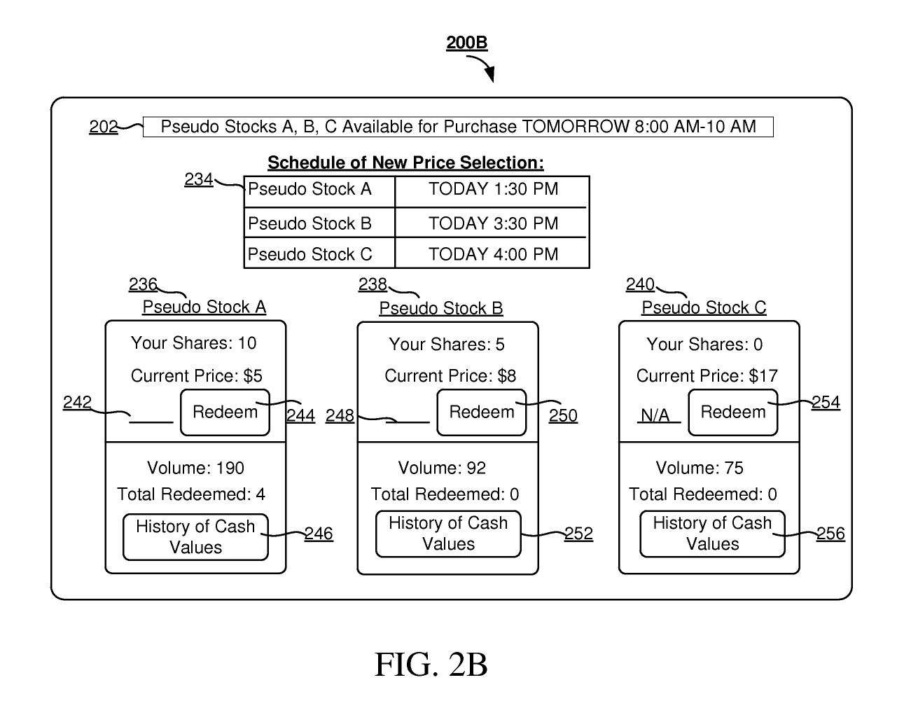

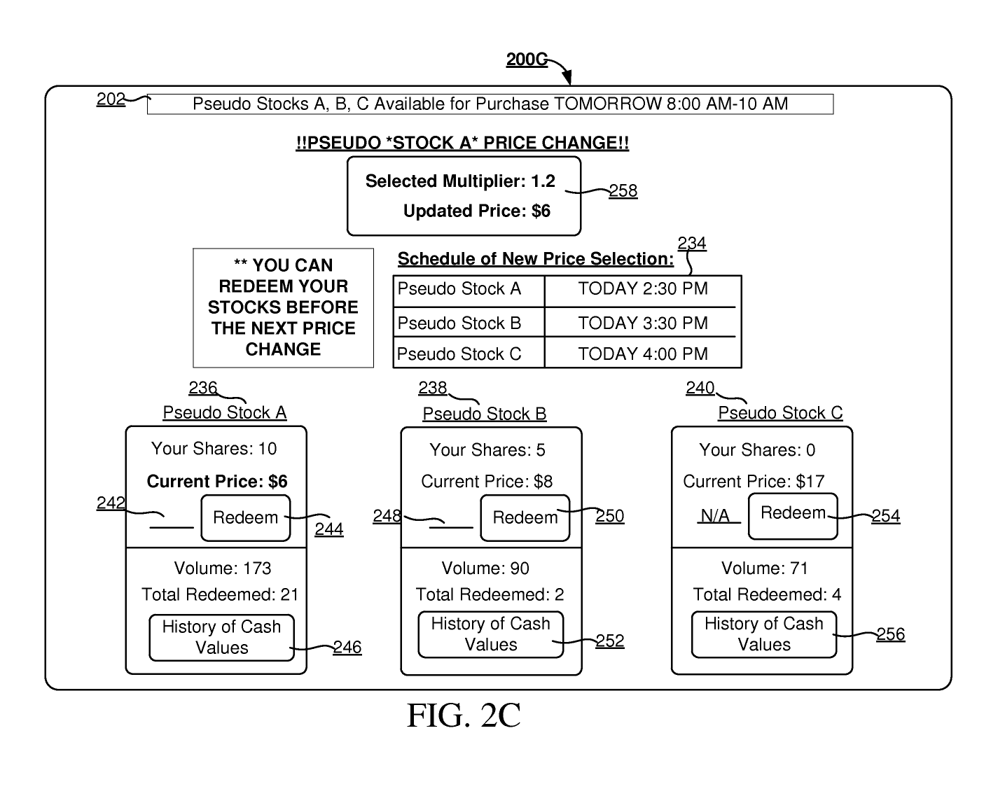

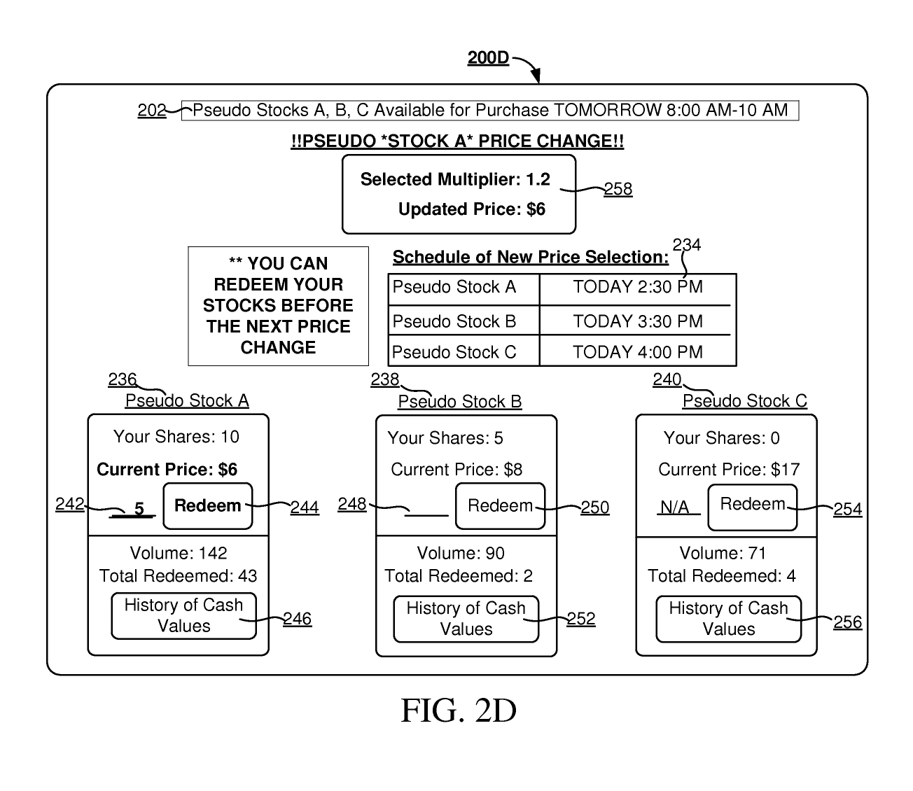

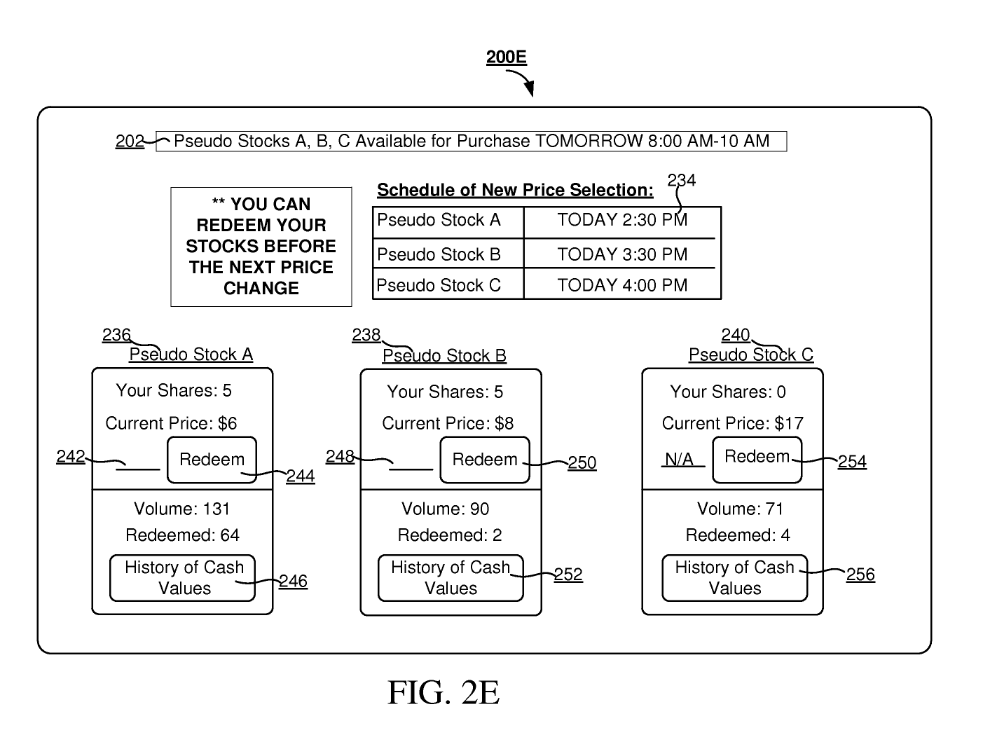

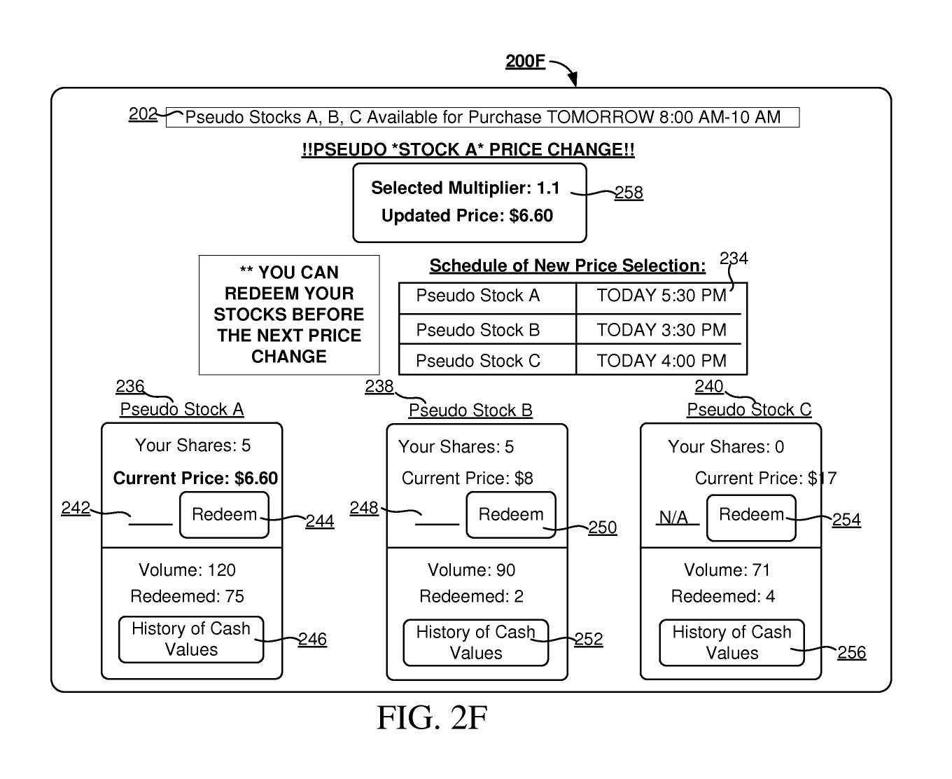

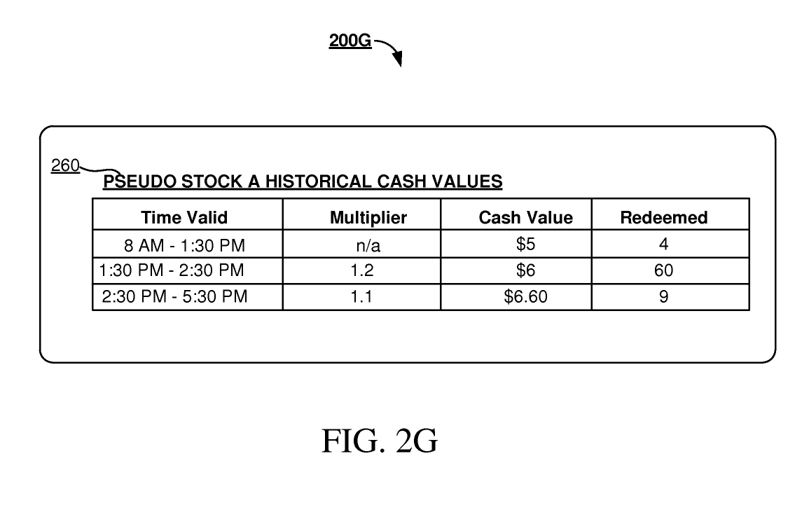

The stepwise social lottery management engine 102 includes a data storage 112, which includes lottery data 114 such as player action data 116, pseudo stocks data 118, and multipliers 120. The pseudo stocks data 118 and the multipliers data 120 are illustrated in FIGS. 2A-2G. The player action data 116 may include aggregated data of player behavior including, but not be limited to, total number of purchased tickets, total number of redeemed tickets, total number of held tickets, total number of pooled tickets, or any combination thereof.

At least one memory device of the stepwise social lottery management engine 102 may store program code (e.g., the modules 104, 106, 108, and 110) and instructions executable by the at least one processor of the stepwise social lottery management engine 102 to control the stepwise social lottery management engine 102. At least one memory device of the stepwise social lottery management engine 102 may store operating data, such as image data, event data, input data, random number generators (RNGs) or pseudo-RNGs, probability data, multipliers data, pseudo stock data, paytable data or information, and/or applicable game rules that relate to the play of one or more games (such as the stepwise social lottery games as described herein).

In various embodiments, part or all of the program code and/or the operating data described above is stored in at least one detachable or removable memory device including, but not limited to, a cartridge, a disk, a CD-ROM, a DVD, a USB memory device, or any other suitable non-transitory computer readable medium.

The stepwise social lottery management engine 102 may include a bus (not shown) or other communication component for communicating information and a processor or processing circuit coupled to the bus for processing information. The stepwise social lottery management engine 102 may include main memory, such as a random access memory (RAM) or other dynamic storage device, coupled to the bus for storing information, and instructions to be executed by the processor(s). The main memory can also be used for storing the lottery data 114 or other intermediate information during execution of instructions by the processor. The stepwise social lottery management engine 102 may further include a read only memory (ROM) or other static storage device coupled to the bus for storing static information and instructions for the processor. A storage device (e.g., data storage 112), such as a solid state device, magnetic disk or optical disk, is coupled to the bus for persistently storing information and instructions.

The stepwise social lottery management engine 102 may be coupled via the bus to a display, such as a liquid crystal display, or active matrix display, for displaying information to a user (e.g., an administrator of the lottery game). An input device, such as a keyboard including alphanumeric and other keys, may be coupled to the bus for communicating information and command selections to the processor. In another implementation, the input device has a touch screen display. The input device can include a cursor control, such as a mouse, a trackball, or cursor direction keys, for communicating direction information and command selections to the processor and for controlling cursor movement on the display.

According to various implementations, the processes described herein can be implemented by the stepwise social lottery management engine 102 in response to the processor executing an arrangement of instructions contained in main memory. Such instructions can be read into main memory from another computer-readable medium, such as the storage device. Execution of the arrangement of instructions contained in main memory causes the stepwise social lottery management engine 102 to perform the illustrative processes described herein. One or more processors in a multi-processing arrangement may also be employed to execute the instructions contained in main memory. In alternative implementations, hard-wired circuitry may be used in place of or in combination with software instructions to effect illustrative implementations.

The network 122 may be any form of computer network that relays information between the player computing devices 130-140, and the stepwise social lottery management engine 102. For example, the network 122 may include the Internet and/or other types of data networks, such as a local area network (LAN), a wide area network (WAN), a cellular network, satellite network, or other types of data networks. The network 122 may also include any number of computing devices (e.g., computer, servers, routers, network switches, etc.) that are configured to receive and/or transmit data within the network 122. The network 122 may further include any number of hardwired and/or wireless connections. For example, the player computing device 130 may communicate wirelessly (e.g., via Wi-Fi, cellular, radio, etc.) with a transceiver that is hardwired (e.g., via a fiber optic cable, a CAT5 cable, etc.) to other player computing devices and/or the engine 102 in the network 122.

In some embodiments, a stepwise social lottery game may incorporate some aspects of trading on financial markets, such as trading of stocks or foreign currency exchange. In these embodiments, the lottery offers tickets (corresponding to shares) of multiple “pseudo stocks” (e.g., corresponding to companies, properties, currencies, or the like), with each pseudo stock identifiable by a distinctive name or mark.

Players may purchase pseudo stocks tickets from the stepwise social lottery at a predetermined price, within a pre-defined origin time window (e.g., between 8:00 AM to 10:00 AM daily). The lottery may provide players with current and accurate information concerning the volume of tickets of each pseudo stock being purchased.

The stepwise social lottery may determine the cash value of any ticket of each pseudo stock, after the origin period, by a stepwise random process. In one implementation, at each step, the lottery randomly selects a multiplier from among a set of possible multipliers. Some members of the field of multipliers may be greater than one, and some may be less than one. The current value of the pseudo stock ticket changes by the factor of the multiplier randomly chosen by the lottery. The action of the multipliers may be compound (e.g., multipliers of 1.1 and 1.2 in successive steps determine a current cash value 1.32 times the purchase price).

The stepwise social lottery may have pre-defined the set of multipliers and their probabilities so that the long-term, average, expected value of a pseudo stock ticket after each drawing is less than before the drawing. However, since some multipliers are greater than one, a significant probability exists that the value of the ticket after each drawing will be greater than before the drawing. For instance, a set of multipliers may be defined as in the table below, such that the long-term, average, expected value of multipliers from this array is equal to 0.8824, while at each drawing the likelihood that the value of the ticket will increase is 32%.

TABLE 1

| Multiplier | Multiplier |
|---|---|
| Value | Count |
| 0.5 | 10 |
| 0.6 | 20 |
| 0.7 | 25 |
| 0.8 | 20 |
| 0.9 | 5 |
| 1 | 5 |
| 1.1 | 10 |
| 1.2 | 12 |
| 1.3 | 8 |
| 1.4 | 5 |
| 1.5 | 5 |

The selection of a multiplier may occur in multiple steps during the active life of the lottery ticket. The schedule of these steps may (but need not) be made available to the players. Each multiplier selection event may be independent. A single multiplier may be selected for all tickets of particular pseudo stock type. All tickets of the game that are still in play may change value together. At each step, the lottery game may provide the players with the history of cash value of individual tickets of each pseudo stock. During the time between the multiplier selection events, players may choose to redeem any ticket for its current cash value. The stepwise social lottery game continually publishes current and accurate information concerning the volume of tickets of each pseudo stock being redeemed. In some embodiments, the value determined by the set of multipliers chosen in all the scheduled draws is the final value of the ticket, which does not change further until the ticket expires as an “unclaimed prize”.

Accordingly, during play of the stepwise social lottery, multiple players contemporaneously face similar choices, and each player receives up to date feedback about the actions taken by others. Even if a player happens to be the only one on the network currently active, learning this by observing feedback provides a social context. As a result, the social context feature of the stepwise social lottery game makes it well suited to play on the large distributed networks (e.g., networks that are currently maintained by lotteries). However, it should be understood that the stepwise lottery game may be used by other organizations that use the Internet data network (or other type of network) to offer gaming and gambling that allows for engagement of multiple players contemporaneously. Thus, the stepwise social lottery game can be used by government lotteries and other organizations.

FIGS. 2A-2G provide illustrations of user interfaces of a stepwise social lottery game during which stepwise and repetitive selection of multipliers entirely defines outcomes in the lottery game, and players are provided with a social context for the players' choices. As illustrated in FIGS. 2A-2G, the stepwise social lottery game allows players to purchase different types of pseudo stocks, with each pseudo stock changing value at prescheduled times. The players may be provided with information regarding activity of other players (e.g., volume of redeemed stocks), and given an option to cash in their tickets at the current stock cash values. Using the player activity data, the players may decide if they want to cash in at least some of their tickets.

The user interfaces 200A-200G may be shown to the player in one or more web pages provided by a web page browser. In some embodiments, the user interfaces 200A-200G may be shown to the player by an application (e.g., a desktop application, a smartphone application) installed on a player computing device.

FIG. 2A illustrates a stepwise social lottery game user interface 200A displaying three pseudo stocks available for purchase. An area 202 in the user interface 200A provides information about the time window that the pseudo stocks A, B, and C are available for purchase. In particular, the area 202 indicates that the pseudo stocks A, B, and C are available for purchase today between 8:00 AM and 10 AM. Accordingly, a limited time period is provided to the players during which pseudo stocks may be purchased at the predetermined prices. After the time period indicated in the area 202 expires, the players may no longer be allowed to purchase the stocks at the prices indicated in the user interface 200A, and may need to wait until the next period of time during which the stocks will be available for purchase again. In some embodiments, during the next time period when the stocks will be available for purchase, the price of the stocks may be different than during the current time period.

Area 204 displays information regarding the pseudo stock A including volume data 210 and initial price data 212. As shown, the initial price of the stock A is $5, and a total of 127 stocks have been purchased so far at this price. In section 214, the player may indicate a number of stocks that the player wishes to purchase at the initial price of $5, and hit the button 216 to initiate the purchase.

Similar to the area 204, an area 206 displays information regarding the pseudo stock B including volume data 218 and initial price data 220. As shown, the initial price of the pseudo stock B is $8, and a total of 66 stocks have been purchased so far at this price. In section 222, the player may indicate a number of pseudo B stocks that the player wishes to purchase at the initial price of $8, and hit the button 224 to initiate the purchase of the pseudo stock B.

An area 208 displays information regarding the pseudo stock C including volume data 226 and initial price data 228. As shown, the initial price of the stock A is $17, and a total of 45 stocks have been purchased so far at this price. In section 230, the player may indicate a number of stocks that the player wishes to purchase at the initial price of $17, and hit the button 232 to initiate the purchase of the pseudo stock C.

Although areas 204, 206, and 208 display volume and initial price data regarding the respective pseudo stocks, other information may be displayed to the player including, but not limited to, historical price data, historical volume data, historical player activity data (e.g., volume of stock redeemed), etc. The layout and the data presented in the user interface 200A is provided for illustrative purposes only, and this data and/or other data may be presented to the player in any other manner. Although data regarding three pseudo stocks (i.e., pseudo stocks A, B, C) is shown in FIG. 2A, data for any number of pseudo stocks or any other types of wager items may be shown. The wager items may have any name, and the names of pseudo stocks A, B, C are provided for illustrative purposes only.

Once the two hours period between 8 AM and 10 AM lapses, the sections 214, 222, and 230, and the buttons 216, 224, and 232 may be disabled or not shown to the players, until the next time period of purchasing stocks becomes available again. In some embodiments, when pseudo stocks A, B, and C are not currently available for purchase by players, a user interface 200B shown in FIG. 2B (or another user interface) may be presented to the player allowing them to redeem some or all of their outstanding stocks, and view activity information of other players.

As shown in FIG. 2B, the area 202 displays updated time period during which the pseudo stocks will be available for purchase (i.e., 8:00 AM-10:00 AM of the following day). Thus, the player is not able to purchase additional stocks using FIG. 2B as those stocks are not available for purchase until the indicated time period.

The user interface 200B includes a table 234 of a schedule of price updates to the pseudo stocks A, B, and C. In some embodiments, the table 234 is not provided to the player. As shown in the table 234, the price of the pseudo stock A will change today at 1:30 pm, while the price of the pseudo stock B will change today at 3:30 pm, and the price of the pseudo stock C will change today at 4:00 pm. The player may be allowed to hide the table 234 by selecting an indicator in the user interface 200B (not shown).

The specific times identified in the table 234 may be predetermined by a central stepwise lottery engine (e.g., the engine 102). In some embodiments, the times for the pseudo stock changes may be selected by the central stepwise lottery engine 102 based on historical stock price changes, the information collected about the player actions (e.g., information of when the players are most actively engaged with the lottery), etc. In some embodiments, the central stepwise lottery engine 102 may introduce an element of randomness to the times for the pseudo stock changes. In other embodiments, the times for the pseudo stock changes may be the same every day, and/or may change periodically. In other embodiments, the times for the pseudo stock changes may change as determined by the central stepwise lottery engine 102 based on one or more criteria. This adds a further dimension for consideration, as the next opportunity for action may or may not occur at a time convenient for the player.

Each area 236, 238, and 240 displays the number of shares the player owns and the current stock price of the respective pseudo stock. The player can redeem one or more shares of pseudo stocks A or B by providing the number of shares that they wish to redeem (in the space 242 or 248) and selecting the “redeem” button (i.e., button 244 or button 250). Because the player does not own any shares of the pseudo stock C, the player is unable to redeem any shares of that stock.

The lower portion of each area 236, 238, and 240 provides current aggregate player action information associated with each stock. As shown, a total of 190 shares of the pseudo stock A have been purchased, while a total of 4 shares have been redeemed thus far, while 92 shares of pseudo stock B and 75 shares of pseudo stock C have been purchased by players, and no shares of stocks B and C have been redeemed yet. The aggregate player action data may be updated intermittently to reflect the current stock volume and number of redeemed shares. This distribution of the up to date aggregate activity data of players may make the lottery game more engaging and interesting for the players. “History of cash values” buttons 246, 252, and 256 enable players to view historical cash values of the respective stocks. FIG. 2G illustrates historical values of pseudo stock A.

The players may wish to redeem some or all of the stocks that they own by providing the number of shares that they wish to redeem and pressing the “redeem” button. For example, the player may wish to redeem five shares of pseudo stock A, and the player may enter the amount of 5 in the area 242 and hit the button 244 to initiate the redemption process. Because the player owns no shares of pseudo stock C, the player is not allowed to redeem any shares of that stock. Since the current price has not changed yet, the player may wish to hold the shares and wait to see the next one or more price changes and activity data of other players to determine whether to redeem their shares.

Prices of the pseudo stocks A, B, and C change in accordance with the price change table 234. As shown in the price change table 234 in FIG. 2B, the first price change is a price change of pseudo stock A at 1:30 pm today. In FIG. 2C, a user interface 200C is an illustration of a price change of the pseudo stock A. As shown in a section 258 of a user interface 200C, a multiplier of 1.2 was selected, and the new price of the pseudo stock A is $6 (i.e., the previous price*multiplier=$5*1.2). The schedule of new price selection table 234 reflects the next price selection for pseudo stock A (i.e., 2:30 PM today).

The area 236 displays the new price for the pseudo stock A of $6. All shares of stock A change price at the same time to the newly selected price of $6. The prices for pseudo stocks B and C remains the same as in FIG. 2B until their respective prices are updated according to the schedule of price selection shown in table 234. Accordingly, the price of the pseudo stock B is still $8 and the price of the pseudo stock C is $17. As shown in the user interface 200C, the player has not redeemed any of his shares, and still owns ten shares of pseudo stock A and five shares of pseudo stock B. At this point in the lottery game, the player is given a choice of holding on to the shares of pseudo stocks A and B, or redeeming any number of their outstanding stocks at the current prices. For example, the player may choose to redeem four shares of pseudo stock A at the new price of $6 and five shares of pseudo stock B at the price of $8. The player activity data including the volume and the total number of redeemed shares provides the player with aggregate information of what other players are doing under similar circumstances.

The volume and the total redeemed number of tickets for each pseudo stock are updated as shown. For example, a total of 173 shares are outstanding of pseudo stock A, while 21 shares have been redeemed. The number of redeemed shares includes shares that were redeemed at the new current price of $6.

User interface 200D of the stepwise social lottery game illustrates the player redeeming shares of pseudo stock A. As shown, the player indicated in the area 242 that the number of shares that they would like to cash in is five. By selecting the button 244, the process of redeeming the five shares of pseudo stock A at the price of $6 is initiated.

As shown in the table 234, the next time of price selection of pseudo stock A is set to be at 2:30 pm today. The player has the option of redeeming the shares of stock A prior to 2:30 pm at the price of $6. After 2:30 pm, the price of stock A will change, and the player will no longer be allowed to redeem pseudo stock A shares at the price of $6. Thus, the player has to make a choice whether to redeem, some, all, or no shares of pseudo stock A at the current price of $6 in the limited time window (i.e., prior to 2:30 PM today). The player activity data displayed for each pseudo stock makes this decision making more interesting as the player may take into account what other players are doing currently while relying on the same set of information (i.e., the current price of the stock, volume of the stock, and the number of shares redeemed by other players).

FIG. 2E illustrates a user interface 200E of the stepwise social lottery game before the next price change of pseudo stock A and after the player redeemed five shares of pseudo stock A as shown in FIG. 2D. As shown, in the table 234, the next price change for the pseudo stock A will occur at 2:30 pm. The pseudo stock A section 236 illustrates that the player owns five shares and that the current price of the pseudo stock A is $6. The player may still opt to redeem one or more of their remaining 5 shares of pseudo stock A. The total number of redeemed shares of pseudo stock A is 64, while very few shares of pseudo stocks B and C have been redeemed by players (i.e., 2 shares of pseudo stock B have been redeemed and 4 shares of pseudo stock C have been redeemed). The prices of pseudo stocks B and C have not yet changed and the players may be waiting to see what the prices will change to prior to deciding to redeem any of their shares.

FIG. 2F illustrates selection of a new multiplier and an update to price of the pseudo stock A. As shown in the user interface 200F of the stepwise social lottery game, the price of the pseudo stock A has changed to $6.60. In particular, the section 258 displays that a multiplier of 1.1 was selected and applied to the previous price of $6 to produce the new updated price of $6.60. The multipliers are applied cumulatively to the initial price (i.e., the multiplier 1.2 and 1.1 applied to the initial price result in the new price of $6.60). In other words, the newly selected multiplier having value of 1.1 is applied to the previous price of $6.

As shown in the table 234, the next schedule time for the price change of the pseudo stock A is updated to 5:30 pm today. The timing of the price changes are determined by the central lottery game engine. The first price change to the pseudo stock B is scheduled for 3:30 pm today, while the first price change to the pseudo stock C is scheduled for 4:00 pm today.

Prior to the next scheduled price change; the player has a choice of redeeming any of the five outstanding shares of the pseudo stock A at the new price of $6.60. The player may no longer redeem the shares of pseudo stock A at the price of $6. Accordingly, the player has a limited amount of time during which he can redeem shares of pseudo stock A at the current price of $6.60. For example, the player may be allowed to redeem their pseudo stocks A prior to the next scheduled new price selection (i.e., prior to 5:30 pm today), or prior to another time that may be provided to the player (e.g., a predetermined time prior to the next schedule new price selection time).

The user interface 200F displays updated aggregate player activity data including updated volume and total number of redeemed shares of each pseudo stock. As shown, seventy five shares of pseudo stock A have been redeemed, leaving one hundred twenty outstanding shares. The number of redeemed shares of pseudo stocks B and C have not changed, and remain at two and four shares respectively. This activity data of players engaged in the stepwise social lottery game provides the player with context of what other players are doing with the same set of information and makes the stepwise social lottery game more engaging and interesting.

Upon player selection of a “history of cash values” button (e.g., the button 246, 252, or 256), the player is provided with historical information of cash values of the respective pseudo stock. FIG. 2G illustrates an exemplary user interface 200G showing a table 260 of pseudo stock A historical cash values. The user interface 200G is shown to the player upon player selecting the button 246.

The table 260 provides the time periods during which the pseudo stock A had different cash values (i.e., prices), along with the multiplier that was selected and applied to the previous price to arrive at the current cash value, as well as a total number of redeemed shares during each time period. For example, between 8:00 AM and 1:30 PM, no multiplier was selected as the initial price was $5, and 4 shares were redeemed. Then between 1:30 PM and 2:30 PM, the multiplier of 1.2 was selected and the new cash value was $6, with a total of 60 shares redeemed during this time period at the price of $6. Finally, the last entry in the table 260 illustrates the data between the time period of 2:30 PM and 5:30 PM during which a multiplier of 1.1 was selected causing the price to change to $6.60, with a total of 9 shares redeemed during this time window. Although the table 260 displays the time periods, multiplier, current cash value, number of redeemed shares, any combination of this data may be shown along with other additional data (e.g., volume data, data related to the player viewing the table 260, etc.).

Although FIGS. 2A-2G illustrate a stepwise lottery game that involves purchasing and redeeming various pseudo stocks, any other type of wager item may be used instead of the “pseudo stocks”. Each wager item of the same wager item type may have the same initial price, and change value similar to the illustrations provided in FIGS. 2A-2G (e.g., by consecutive selection of multipliers at predetermined times), with the player allowed to take actions in between changes of values of the wager items.

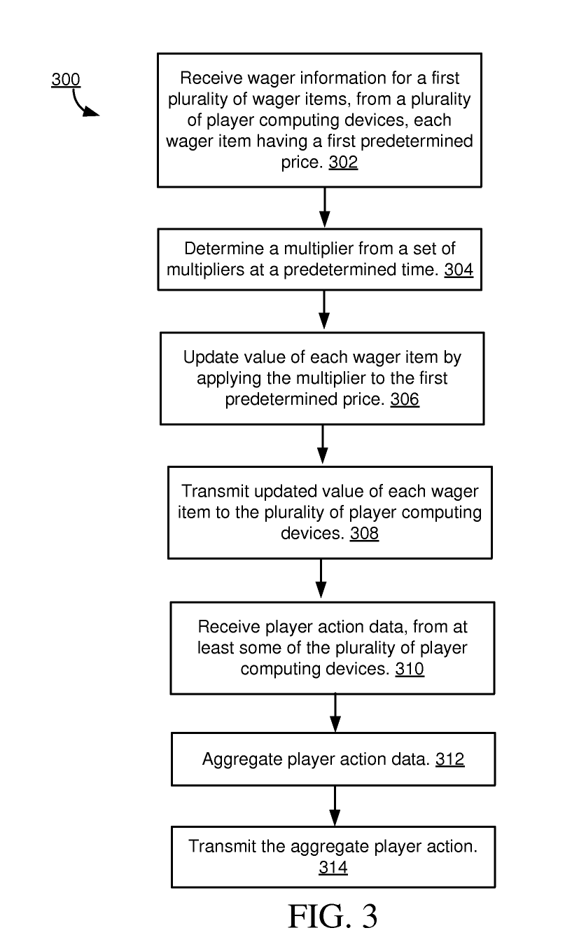

FIG. 3 is a flow diagram of a process 300 for providing a game that allows for periodic changes to the value of wager items using randomly selected multiplier values, and the distribution of information about the actions taken by players as active agents. The process 300 can be implemented on a computing device (e.g., the stepwise social lottery management engine 102, a server, etc.). In one embodiment, the process 300 is encoded on a computer-readable medium that contains instructions that, when executed by the computing device, cause the computing device to perform operations of the process 300.

The process 300 includes receiving (302) wager information (e.g., by a gaming module 104 or another module or component of the engine 102) for a first plurality of wager items, from a plurality of player computing devices. The wager items may be of a first type of wager item. For example, the wager items may be pseudo stock A tickets (as illustrated in FIG. 2A). Each wager item in the plurality of wager items may have the same first predetermined price. The plurality of wager items may be purchased during a predetermined time period. For example, as shown in FIG. 2A, pseudo stock A tickets may be purchased between 8:00 AM and LOAM at a price of $5. Thus, all the tickets purchased by players within the allowed time period have the same initial price.

The process 300 further includes determining (block 304) a multiplier from a set of multipliers at a predetermined time. The multiplier may be determined randomly or pseudo-randomly from the set of multipliers, without replacement (or with replacement), by a ticket values calculator 106 or another module or component of the engine 102. This random determination may be provided through utilization of a true random number generator (“RNG”) or pseudo-RNG, or any other suitable randomization process.

The set of available multipliers may be predetermined by the stepwise social lottery management engine 102. In some embodiments, the set of multipliers and their probabilities may be defined so that the long-term average, expected value of a ticket (e.g., pseudo stock ticket) after each drawing is less than before the drawing. Some members of the set of multipliers may be greater than one, while some of the multipliers may be less than one. Because some of the multipliers are greater than one, a significant probability may exist that the value of the ticket after each drawing may be greater than before the drawing.

At block 306, value of each wager item is updated (e.g., by the ticket values calculator 106) by applying the multiplier to the first predetermined price. As a result, the value of each wager item changes by the factor of the randomly chosen multiplier. Accordingly, each wager item has the same updated price. FIG. 2D illustrates an example of a selected multiplier having value 1.2 applied to the initial price value (i.e., $5) of pseudo stock A, resulting in a value of $6.

The updated value of each wager item is transmitted (block 308) to the plurality of player computing devices. In turn, the player computing devices may display the updated wager item price to the players (e.g., as shown in FIGS. 2D and 2F).

Player action data is received (block 310) from at least some of the plurality of player computing devices. At least some of the players of the plurality of player computing device may have taken action based at least in part on the updated values of wager items, and the aggregate player action data (if available) provided to them. For example, some of the players may have decided to redeem their tickets at the updated value of the wager items, to pool their tickets with other players, and/or to hold their tickets until the next update to the value of the wager items.

The received player action data is aggregated (block 312) (e.g., by the player action tracker module 108). For example, personally identifiable information of players or their player computing devices may be removed. In some embodiments volume data is calculated for each type of allowed player action. For example, the aggregate player action data may include for each type of wager item a total number of redeemed wager items (i.e., “cashed out early” wager items), a total number of pooled wager items, a total number of wager items still “held” by players, etc. The aggregate player action data may include a total number of purchased wager items (including by wager item type).

The aggregate player action data is transmitted (block 312) to the plurality of player computing devices (e.g., by the player action reporting module 110). In turn, the player computing devices may display the aggregate player action data to the players. As the aggregate player action data is updated with incoming new player action data, the up to date aggregate player action data is transmitted to the player computing devices for display to the players. Accordingly, the player is provided with up to date data regarding actions of other players during the same game. Thus, the lottery game provides social context of play to players, when multiple players face similar choices during a time-limited opportunity for action.

A request may be received to redeem a first wager item at the updated price. The request may be received from one of player computing devices. The request to redeem wager items may be initiated by a player utilizing the player computing device to play the stepwise social lottery game. Processing of the request may be performed including providing the value of the redeemed ticket (e.g., $6) to the player.

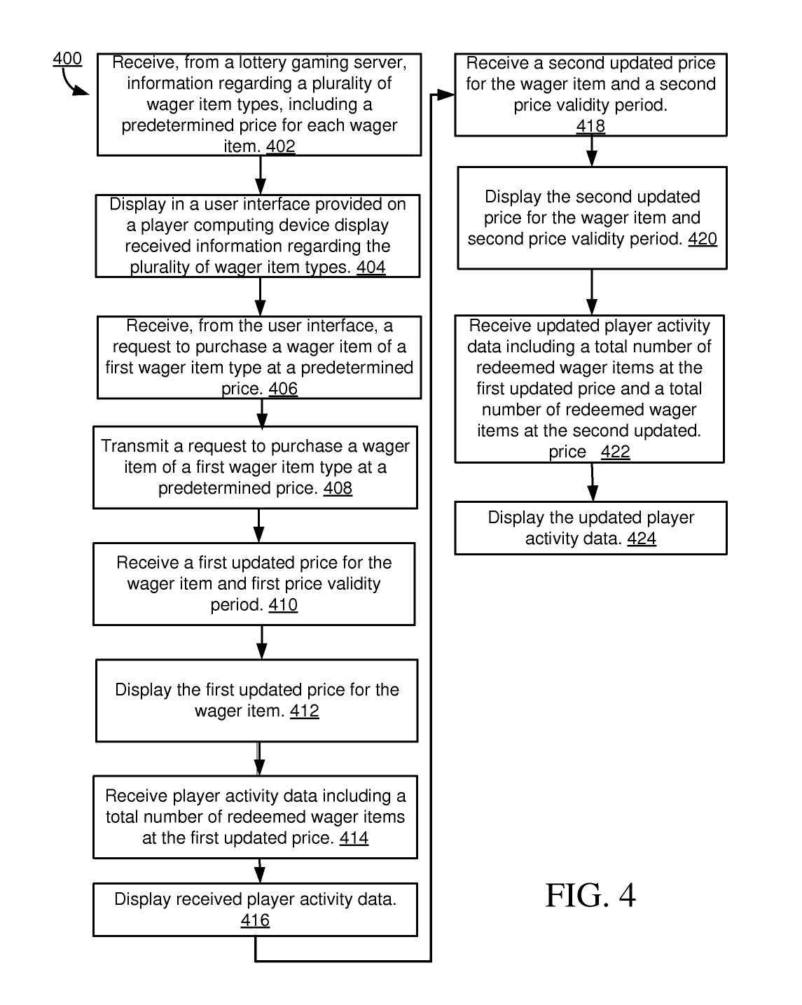

FIG. 4 is a flow diagram of a process 400 for providing a stepwise social lottery game to a player. The process 400 can be implemented on a computing device (e.g., player computing device 130). In one embodiment, the process 400 is encoded on a computer-readable medium that contains instructions that, when executed by the computing device, cause the computing device to perform operations of the process 400.

The process 400 includes receiving (block 402), from a lottery gaming server (e.g., of the engine 102), information regarding a plurality of wager item types, including a predetermined price for each wager item. Received information regarding the plurality of wager item types is displayed (block 404) in a user interface provided on a player computing device display. FIG. 2A provides an illustration of displaying information for different wager item types. For example, as shown in FIG. 2A, information including volume and initial price are shown to the player for three types of wager items (i.e., pseudo stock A, pseudo stock B, and pseudo stock C).

A request is received (block 406), from the user interface, to purchase a wager item of a first wager item type at a predetermined price. The request may be initiated by the player using the user interface. For example, as shown in FIG. 2A, the player requested to purchase ten pseudo stock A items by entering the quantity and selecting the button 216. The player may select any allowed quantity of wager items of one or more wager item type. The first wager item type may be one of the wager item types from the plurality of wager item types.

A request to purchase a wager item of the first wager type at the predetermined price is transmitted (block 408). The request may be transmitted to a central lottery gaming engine (e.g., the engine 102) for processing. For example, the central lottery gaming engine 102 may update its records with the purchase of the wager item of the first wager type at the predetermined price by the player. The central lottery gaming engine 102 may receive requests from multiple players to purchase wager items of various wager item types. As the central lottery gaming engine 102 receives these requests, it may update its data accordingly (including aggregate player action data).

At block 410, a first updated price for the wager item is received. The first updated price for the wager item may be determined by the central lottery gaming engine 102. In some embodiments, the first updated price is determined by applying a selected multiplier. The multiplier may be selected randomly from a predetermined set of multipliers. The first updated price is displayed (block 412) on the user interface to the player. The player may be allowed to redeem their wager item at the first updated price during a predetermined validity period. For example, the user interface may indicate to the player the timing of the next update to the price of the wager item. In this example, the player is allowed to redeem their wager item at the first updated price only during the period of time before the next update to the price (or during a shorter predetermined period of time). Thus, the player faces a choice of holding on to the wager item or redeeming it at the first updated price.

Player activity data including a total number of redeemed wager items at the first updated price is received (block 414). The player activity data may include data regarding other players playing the same stepwise social lottery game. In particular, the player activity data may include total number of tickets that were redeemed for each type of wager item, historical player activity data, etc. The player activity data may be received intermittently from the central lottery gaming engine. In some embodiments, the central lottery gaming engine may transmit updated player activity data to the player computing devices on a predetermined intermittent basis (e.g., for every two minutes).

The received player activity data is displayed (block 416) to the player by the player computing device. The received player activity data may be displayed on the display of the player computing device in the user interface, or in another user interface. In some embodiments, the player may retrieve the player activity data by selecting a control (e.g., a checkbox, button, etc.) on the user interface. In these embodiments, a request for updated player activity data may be transmitted to the central server or engine, and the received player activity data displayed to the player.

At block 418, a second updated price is received for the wager item. The second updated price may be determined by the central server or engine by selecting a multiplier from a set of predetermined multipliers. The second updated price may be higher or lower than the first updated price. The received second updated price for the wager item is displayed (block 420) to the player on the display of the player computer device in the user interface or in another user interface. Along with the second updated price, information regarding the period of time during which the second updated price is available to the player may be received. Thus, the player as active agent has the choice to accept an offered outcome, or to decline this outcome in favor of a future outcome.

For example, information regarding the timing of the next price update may be received and displayed to the player. In this example, the player may be able to redeem the wager item for the second updated price before the next time that the new price for the wager item is to be selected. In another embodiment, price validity period for the second updated price is received and displayed to the player, during which the player may redeem their wager item. In this embodiment, the selection of the new updated price may occur after the price validity period lapses.

Updated player activity data is received (block 422) and displayed (block 424) to the player. The updated player activity data may include an up to date total number of redeemed wager items at the first updated price, and a total number of redeemed wager items at the second updated price. The total number of redeemed wager items at the second updated may be intermittently updated, while the final total number of redeemed wager items at the first updated price may not change as players are no longer allowed to redeem their wager items at the first updated price. A total number of all redeemed wager items (i.e., including the total number of wager items redeemed at the first updated price and the total number of wager items redeemed thus far at the second updated price) of the first wager item type may be received and displayed to the player. Advantageously, displaying up to date activity data of other players may make playing the lottery game more interesting and engaging for the player.

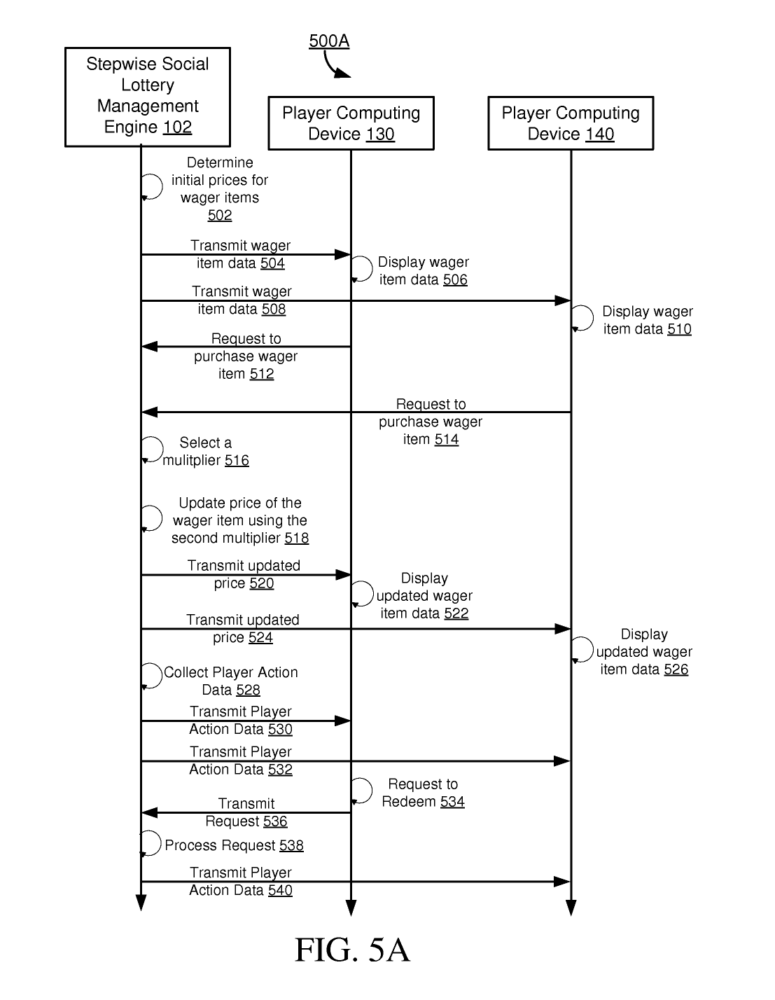

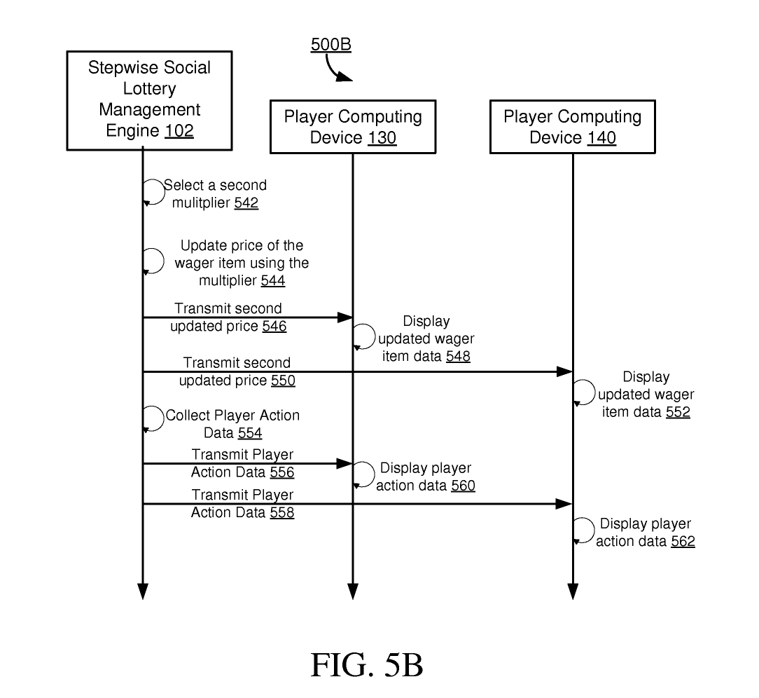

FIGS. 5A-5B illustrates flow diagrams between the stepwise social lottery management engine 102, and player computing devices 130 and 140, in accordance with illustrative embodiment. Although only two player computing devices are shown, the stepwise social lottery management engine 102 may transmit data to and receive data from any number of player computing devices (e.g., 100 player computing devices, 10000 player computing devices, etc.).

The stepwise social lottery management engine 102 determines (block 502) initial prices for wager items. In some embodiments, wager items of the same wager item type may be assigned the same initial price. For example, the initial price of the pseudo stock A may be $5, in which case all the tickets of the pseudo stock A would have the initial price of $5. In this example, tickets of another type of stock may have different initial price (e.g., pseudo stock B tickets may all have initial price $8). In some embodiments, the initial prices may be determined randomly from a set of predetermined initial prices. The initial prices can take any value chosen by the lottery.

The wager item data is transmitted (block 504) by the stepwise social lottery management engine 102 to the player computing device 130, which in turn displays (block 506) the wager item data to the player playing the lottery game using the player computing device 130. The wager item data is transmitted (block 508) by the stepwise social lottery management engine 102 to the player computing device 140, which in turn displays (block 510) the wager item to the player playing the lottery game using the player computing device 140. Accordingly, the players playing the lottery game on two different player computing devices 130 and 140 are provided with the same wager item data.

Although not shown, the stepwise social lottery management engine 102 may transmit data to, and collect data from other player computing devices including requests to purchase wager items of one or more wager item type, and provide the player activity data to the player computing devices 130 and 140 including the total number of purchased wager items of each wager item type. As a result, the players of the player computing devices 130 and 140 may utilize the information on the volume of purchased wager items of each wager item type in determining how many wager items to purchase. The player activity data may be intermittently updated, so that the players are provided with up to date information.

The player may decide to purchase a wager item using a user interface provided by the player computing device 130. As a result, at block 512, the player computing device 130 transmits a request to purchase a wager item to the stepwise social lottery management engine 102. The wager item may be of a first wager item type. Although not shown in FIG. 5A, the player may purchase multiple wager items of the first wager item type and/or of other wager item types. Upon receiving the request to purchase the wager item, the stepwise social lottery management engine 102 may update its records (e.g., the lottery data 114) to record the player's purchase of the wager item. In some embodiments, the stepwise social lottery management engine 102 may transmit to the player computing devices 130 and 140 and other player computing devices updated player activity information including the player's purchase of the wager item.

The player of the player computing device 140 may decide to purchase a wager item using a user interface (e.g., similar user interface as used by the player of the player computing device 130 to purchase the wager item) provided by the player computing device 140. As a result, at block 514, the player computing device 140 transmits the request to purchase the wager item to the stepwise social lottery management engine 102. The wager item may be of a first wager item type. Although not shown in FIG. 5A, the players of the player computing device 130 and the player computing device 140 may purchase multiple wager items of the first wager item type and/or of other wager item types. For example, the player of the player computing device 130 may purchase five wager items of the first wager item type and four wager items of the second wager item type, while the player of the player computing device 140 may purchase twenty wager items of the first wager item type.

Although not shown, the stepwise social lottery management engine 102 may receive requests to purchase wager items of one or more wager item types. The players may be provided with a time frame during which wager items may be purchased. For example, wager items of the first wager item type may be purchased only between 8 AM and 10 AM at a predetermined initial price. Accordingly, all wager items of the first wager item type purchased by players in the allowed time frame have the same initial value. In some embodiments, as players using various player computing devices purchase wager items, the stepwise social lottery management engine 102 may transmit current volume information of purchased wager items to the player computing devices for display to the players. As a result, the player may be able to view which wager item types are more popular, and use this information in their decision to purchase wager items (including additional wager items).

A multiplier is selected (block 516) for a particular wager item type by the stepwise social lottery management engine 102. In some embodiments, the multiplier may be selected at a predetermined time, which may be shown to the player. In some embodiments, the multiplier is selected randomly or pseudo-randomly from a set of predetermined available multipliers. The selected multiplier is used to update (block 518) the price of all the wager items of the wager item type. More specifically, initial price of the wager items of the first wager item type is multiplied by the selected multiplier. As a result, the values of all the wager items of the first wager item type change to the initial price multiplied by the selected multiplier. The updated price is transmitted (blocks 520 and 524) to the player computing devices 130 and 140, and displayed (blocks 522 and 526) to the players. Other information may be transmitted to the player computing devices 130 and 140 for display to the players including the period of time during which the updated price is valid (e.g., a validity period), the time of the next selection of the multiplier, etc.

Upon receiving the updated price information for wager items of the wager item type, some players may decide to redeem their wager items at the updated price. The stepwise social lottery management engine 102 may collect (block 528) player action data from player computing devices including data regarding players redeeming their wager items for the updated price. The collected player action data may be stored in storage accessible to the stepwise social lottery management engine 102.

The stepwise social lottery management engine 102 may transmit (blocks 530 and 532) the player action data to the player computing devices 130 and 140 and other player computing devices. The player of the player computing device 130 may request to redeem (block 534) one or more their wager items at the updated price, and the request is transmitted (block 536) to the stepwise social lottery management engine 102 for processing (block 538). For example, the player may have ten wager items of the first wager item type, and decide to redeem five of those wager items. In this example, using a user interface of the stepwise social lottery game provided by the player computing device 130, the player may initiate the redemption of five of the ten wager items at the updated price. The player may take into account the player action data that is provided by the stepwise social lottery management engine 102 in making the decision to redeem some of the wager items at the updated price. The stepwise social lottery management engine 102 processes the request to redeem the wager items and updates its records including the player action data accordingly. The up to date player action data is transmitted (block 540) to the player computing device 140 (and to other player computing devices), which includes the data concerning the player of the player computing device 130 redeeming at least some of their wager items.

As shown in FIG. 5B, a second multiplier is selected (block 542). The second multiplier may be selected randomly or pseudo-randomly from the same set of predetermined multipliers that the first multiplier was selected in block 516. In some embodiments, the value of the first multiplier is not removed from the set of predetermined multipliers. In these embodiments, the value of the second multiplier may be the same as the value of the first selected multiplier. The second selected multiplier may have a value that is larger or smaller than the first multiplier.

The price of the wager items of the first wager item type is updated (block 544) using the second multiplier. The value of the second multiplier is applied to the updated price. As a result, the new value of the wager items reflects both the first multiplier and the second multiplier. In some embodiments, the value of the second updated price may be lower after the second multiplier is applied.

The second updated price of the wager item is transmitted (blocks 546 and 550) to the player computing devices 130 and 140, and then subsequently displayed (blocks 548 and 552) to the players of the player computing devices 130 and 140. Other information may be transmitted to the player computing devices including the total number of wager items redeemed by players at the first updated price, total number of wager items still owned by players, a period of time during which the wager items may be redeemed at the second updated price, a total number of wager items redeemed so far at the updated ticket price, etc.

The stepwise social lottery management engine 102 may collect (block 554) player action data from the player computing devices including requests to redeem the wager items at the updated price. The data storage of the stepwise social lottery management engine 102 may be updated with the collected player activity data. The up to date player action data may be transmitted (blocks 556 and 558) to the player computing devices 130 and 140. The player computing devices 130 and 140 display (blocks 560 and 562) the player action data to their respective players. The player action data may include, but not be limited to, the final total number of wager items redeemed by players at the first updated price, the total number of wager items redeemed so far at the second updated price, historical data of player redeeming wager items in prior stepwise social lottery games.

Although not shown in FIGS. 5A and 5B, additional multipliers may be selected and cumulatively applied to the price of the wager items. As the prices of the wager items change, the players may be allowed to redeem some or all of their wager items at the current updated price. The price of the wager items of the same wager item type change value together. The players owning the wager items of the same wager item type are provided with the same data including up to date player action data, the current price of the wager items, and the allowed period of time during which the players may redeem their wager items at the current price. Thus, the players have to determine whether to redeem any of their wager items or to hold them, while being provided information about actions of other players facing the same circumstances.

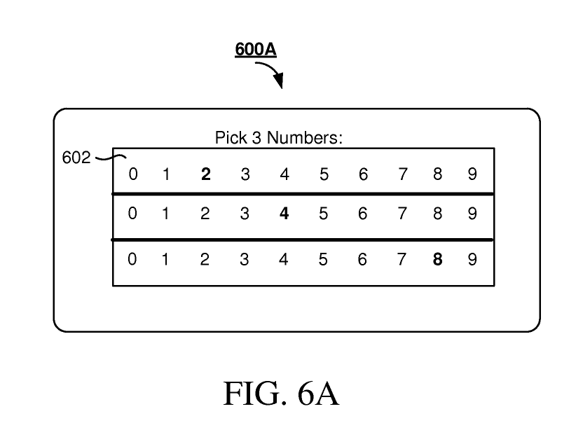

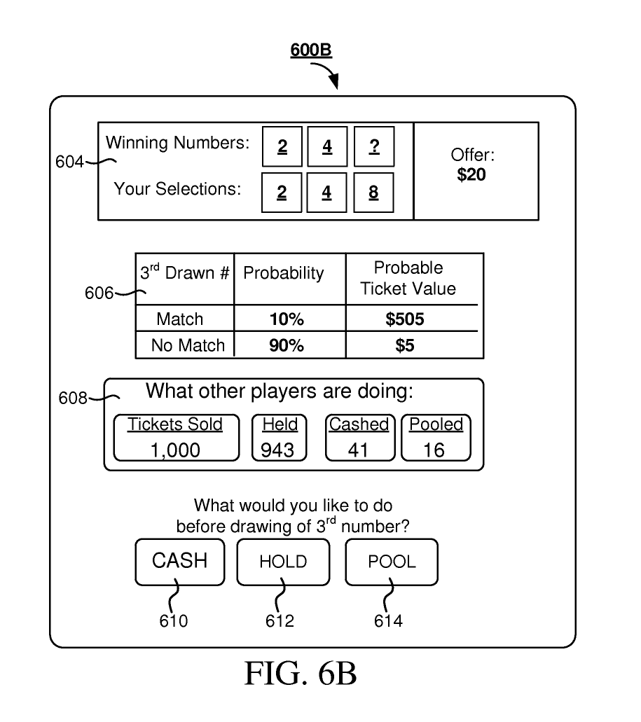

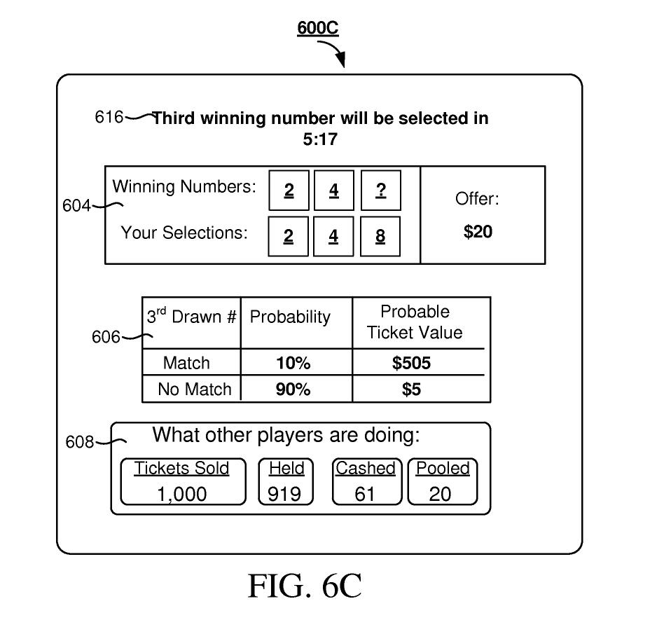

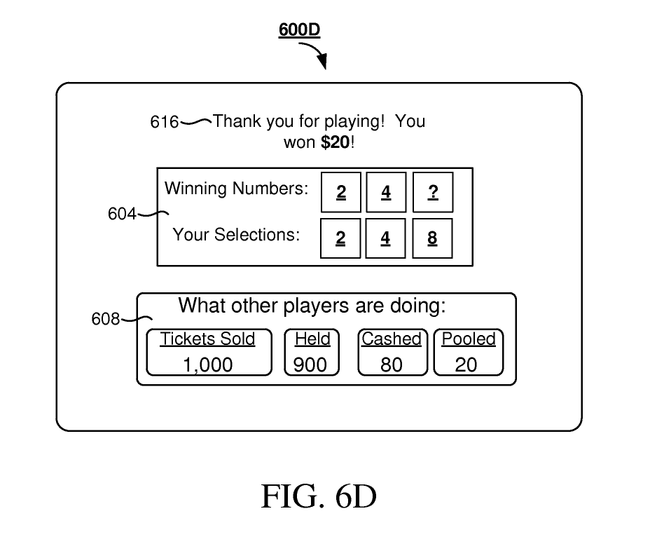

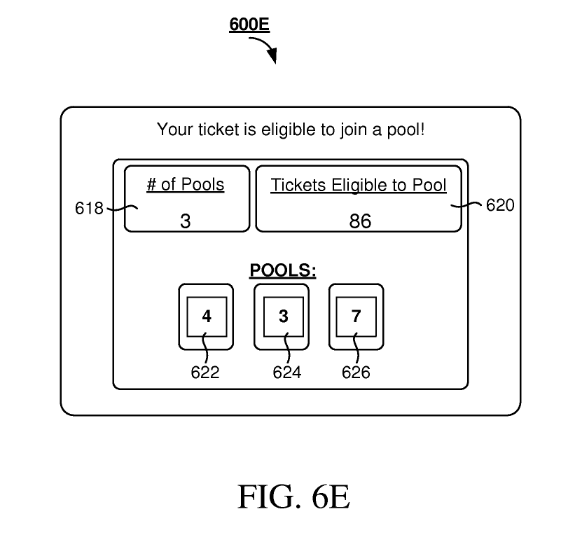

FIGS. 6A-6E, 7, 8, 9A-9B illustrate embodiments of the stepwise social lottery with a traditional lottery numbers game as the base game. The stepwise social lottery version of the lottery numbers game provides a more engaging play experience by enabling players to make choices that affect the financial outcome of their wagers, and by providing information that creates a social context for these choices. In these embodiments, the value-determining procedure executed by the lottery differentiates among tickets such that some tickets of the game become more valuable than others.

In a traditional numbers game, the player when placing a wager repetitively chooses a number from among a prescribed set, and the lottery at a later time randomly repetitively selects a numbers from the same set. Prizes are awarded to players who match all or some of the lottery's random selection. The lottery's selection is made sequentially, and the order of selection is a factor in matching. For example, a game may include the set of numbers in the range of 0 to 9, and the selection is repeated three times from this set. The set of possible results has 1000 elements, represented by the numbers 000 through 999.

The value of prizes awarded in lottery games may be a pari mutuel division of a set prize pool among the winners. For example, the prize pool may be 64% of the value of tickets sold, with the entire prize pool to be distributed pari mutuel (e.g., 79% among those tickets that match the lottery's selection exactly, and 21% among those that match any two out of the three numbers). In this example, it may happen that no player's selection matches the lottery's selection exactly, in which case the share of the prize pool that was designated for the top prize may be retained by the lottery.

The lottery may sell tickets for a game up until just before it randomly selects the winning set of three numbers, with a price being $1 per wager. The complete winning set of numbers is traditionally selected over a span of a minute or two by a procedure involving balls labeled with numbers. The results are then widely disseminated by broadcast and print media and on the Internet. Once players have purchased tickets, and before the lottery begins its selection procedure, the lottery's prize liability (i.e., the amount of money it is obliged to pay) is spread evenly among however many tickets have been purchased. That is, before selection begins, each ticket has an equal expectation to share the prize pool, and in fact each ticket sold for $1 has an expected value of $0.64.

Each of the lottery's three selections of a number from the range 0 to 9 concentrates the prize liability by eliminating the possibility of some tickets to win some prizes. At each step, the expected value of some tickets is reduced, and the expected value of other tickets is increased. The Table 2 below shows how this stepwise concentration of prize value develops, in the game of this example. As shown in the Table 2, there are only eight possible paths of development of a particular ticket toward the final outcome.

TABLE 2

| | outcome: match = 1, no match = 0 | | | prize liability per ticket | | |
|---|---|---|---|---|---|---|
| possible | Step | | | | | |
| paths | 1 | 2 | 3 | 1 | 2 | 3 |
| path 1 | 1 | 1 | 1 | $5.19 | $57.28 | $505.00 |
| path 2 | 1 | 1 | 0 | $5.19 | $57.28 | $4.98 |
| path 3 | 1 | 0 | 1 | $5.19 | $0.75 | $4.98 |
| path 4 | 1 | 0 | 0 | $5.19 | $0.75 | $0.00 |
| path 5 | 0 | 1 | 1 | $0.13 | $0.75 | $4.98 |
| path 6 | 0 | 1 | 0 | $0.13 | $0.75 | $0.00 |
| path 7 | 0 | 0 | 1 | $0.13 | $0.00 | $0.00 |
| path 8 | 0 | 0 | 0 | $0.13 | $0.00 | $0.00 |

The lottery traditionally does not recognize or communicate this stepwise concentration of expected value. Rather, the lottery normally proceeds quickly and without interruption to determine the one selection from the 1000 possible selections that will win the top prize. In fact, the lottery's usual procedure is equivalent to instantly choosing a single outcome from the set of numbers 000 to 999. The lottery also usually offers to pay each ticket matching all three numbers $500 and each ticket matching two of three numbers $5.

In some embodiments disclosed herein, the stepwise social lottery game is applied to traditional numbers lottery game making the lottery's selection of the winning set explicitly stepwise rather than an all-in-one procedure. For example, stepwise social lottery game may sell tickets up until just before it randomly selects the first two of the three winning numbers it must ultimately select. For convenience in illustration, it may be assumed the lottery sells exactly 1,000 tickets at $1 each, so that its total prize liability of $640 is distributed as in the Table 2 shown above, and further that the prize levels after selection of all three numbers are $505 for matching 3 of 3 numbers, and $5 for matching 2 of 3 numbers.

In these embodiments, the stepwise social lottery game may choose the first two numbers, and then disseminates this selection result. This partial selection result will allow some players to ascertain that they hold tickets that have matched both of the numbers selected so far by the lottery. These tickets are sure to win the second-tier prize when the last number is selected. However, it is also true that only those tickets that have matched both of the numbers so far selected can win the top prize. The tickets that match “two of two”, thus, may be said to have both a certain minimum value, and a probable value that is related to their potential to win the top prize. In the Table 2 shown above, the calculated prize liability per ticket for each of the tickets that have matched both of the lottery's selections is $57.28. This includes both the minimum value ($4.98) due to the certain outcome of matching two numbers, and the probable value reflecting each ticket's likelihood to win the top prize of $505.

The stepwise social lottery may advantageously increase the interest of the game by offering holders of these “two of two” tickets the option to cash out before the last number is selected for an offered value that reflects some part of the probable value, in addition to the certain value. The player may elect to cash now, or to hold the ticket to see how its value develops. In setting the value of its offer, the stepwise social lottery game may calculate the expected value of the ticket due to the probability of winning the higher prize tiers, as shown in the Table 2 above. However, in some embodiments, the stepwise social lottery game's object may be not to offer precisely this amount, or to make an offer that is compelling in one way or another, but to set the value of its offer to provide an interesting and perhaps even difficult choice for the player. This will tend to engage the player in evaluating the offer.

To continue with the example, the stepwise social lottery in this case might offer holders of “two of two” tickets $20 to cash out early. The temporary value of $20 is more than the minimum certain end value of $4.98, and less than the calculated share of the total prize liability associated with the ticket ($57.28). The lottery may select a value within this range, in order to more fully engage players in evaluating the offer. Further, the lottery may monitor players' responses and apply this data to inform the future selection of offered values. Player responses that are quick and unequivocally to accept or reject the offer may reflect a lower level of engagement than when responses are slower and more balanced between acceptance and rejection. The stepwise social lottery game management engine 102 may be configured to seek offer values that result in player responses meeting pre-defined criteria for speed or balance. The stepwise social lottery game may provide to the player the information that there is a 90% likelihood that the tickets will be worth only $5 after the third number is chosen. Players can weight this against the 10% likelihood that the ticket will be worth more. The choice may be framed for the player in various ways, for instance: 1) take $20 for sure, versus 2) 10% chance of winning $485, 90% chance of losing $15.

When a player accepts the stepwise social lottery game's offer to “cash out early”, the value of the prize paid may be subtracted from the prize pool, with only the remainder split among those tickets still in play after the last number. The stepwise social lottery game may disseminate information about what other players are doing in the same situation, which the players may use as part of evaluating the stepwise social lottery's offer to “cash out early”. In this example, the stepwise social lottery game may disseminate current and accurate information as to the number and value of two-of-two tickets have been cashed, during the interval between the first selection of winning numbers and the selection of the final winning number. In some embodiments, the stepwise social lottery game may support and/or encourage Internet discussions of the options among interested parties, further to provide social context for players of this game.

In some embodiments, the stepwise social lottery may offer players an additional course of action, in addition to “cashing” or “holding”, which involves “pooling”. Pooling is an alternative to cashing, wherein players surrender individual ownership of the future value of their particular tickets in exchange for membership in a collective of players who have elected to take the same action. The pooled tickets are thus “held” in collective ownership. The value of all prizes won by tickets owned by the collective may be divided among its members, according to the number of tickets contributed by each. The stepwise social lottery game may administer the formation of one or multiple such collectives, and the payment of appropriate shares of winnings. In administering the formation of collectives, the stepwise social lottery game may serve further information such as the number of tickets already in each pool, the number of tickets qualified to join but not yet joined, and so on. In some embodiments, the stepwise social game may allow for pooling of only qualified tickets (i.e., those tickets that are sure winners of something).

To continue further with the example provided above, five holders of “two of two” tickets may elect to pool, and only one of the tickets in the pool matches the lottery's final selection. That ticket earns $505, while the others earn $5 each, for a total of $525. As a result, each ticket in the pool would be paid $105.

After a specified period of time, the stepwise social lottery game may complete the selection of the final winning number and pay winning tickets at their final value (e.g., according to pari mutuel division of the remaining prize pool).

FIGS. 6A-6E provide illustrations of a stepwise social lottery game during which the player selects three numbers, and is provided with temporary ticket value prior to the selection by the lottery of the remaining number(s). The player is then given an option to redeem their ticket at the temporary value, hold on to the ticket to view the final lottery selections, or to pool their ticket. The player is also provided with player action data including number of tickets redeemed by other players at the temporary ticket value. As a result, the player is provided with social context data, which makes the decision of whether to redeem their ticket at the temporary ticket value more interesting and engaging.

The user interfaces 600A-600E may be shown to the player in one or more web pages provided by a web page browser. In some embodiments, the user interfaces 600A-600E may be shown to the player by an application (e.g., a desktop application, a smartphone application) installed on a player computing device.

FIG. 6A displays a user interface 600 providing a table 602 of thirty numbers. As shown, the table 602 includes three rows of numbers from 0 to 9. The player is then allowed to select three numbers from the available numbers in the table 602. The player selected numbers 2, 4, and 8. The player may be able to select the same number three times (e.g., number two three times). In some embodiments, the user interface 600 may allow the player to request that the three numbers are automatically selected for the player.

FIG. 6B provides a user interface 600B displaying partial selection of winning numbers and data helping the player to determine whether to redeem their lottery ticket, hold it until the additional winning number(s) are selected, or pool their ticket with other players. An area 604 displays the numbers selected by the player including numbers 2, 4, and 8, as well as the winning numbers selected by the lottery thus far, which are 2 and 4. As shown, the third number has not been selected by the stepwise social lottery. After the two winning numbers have been selected, the offered value for this ticket is $20, reflecting the lottery's choice determined as described above.

A table 606 displays probability information and probable ticket value after the third number is selected by the lottery game. As shown, there is a 10% chance that the third number will match the player selected number, which would result in a probable ticket value of $505. The probability of the third winning number not matching the player's selected third number is 90%, and in this case the probable ticket value is (rounded to) $5. Accordingly, after the selection of the third number, the value of the ticket may change from $20 to $505 or to $5. Thus, the player is facing the choice of whether to redeem their ticket for $20.

An area 608 provides social context information regarding player behavior in the lottery game. In particular, as shown in the area 608, a total of 1,000 tickets have been purchased. Out of the 1,000 purchased tickets, 41 have been cashed in after the two winning have been selected, and 16 tickets have been pooled. The table 608 may be intermittently (e.g., every minute) updated with current player activity data.

Using the current ticket value, probability data provided in the table 606, and the player activity data displayed in the area 608, the player may make a choice of cashing in the ticket at the currently offered ticket value, holding on to it to see what the third winning number is going to be, or pooling the ticket with other eligible tickets.

Although not shown in FIG. 6B, the allowed time period during which the player can cash or pool their ticket may be displayed. For example, a running timer may be shown to the player indicating to the player how much time is left. Upon the time period during which the play is allowed to cash or pool lapsing, the third winning number may be selected by the lottery game. In other embodiments, there may be a time gap between the period of time during which the player can cash or pool their tickets, and when the third winning number is selected.

A user interface 600C of FIG. 6C may be displayed to the player (e.g., upon the player selecting the button 612). The user interface 600C displays a message 616, which provides the amount of time left before the third winning number will be selected. In some embodiments, the amount of time left before the third winning number is selected is not provided to the player.

The user interface 600C displays the area 604 having the player selections, current ticket value, and the first two winning numbers, as well as the probability table 606. The user interface 600C further includes current player activity data in the area 608. As shown in the table 606, sixty one tickets have been now cashed and twenty tickets have been pooled. The player activity data shown in the table 606 is continuously updated in real-time or in near real-time, so that up to date player activity data is available to the player. In some embodiments, when the player selects the hold button 612, the player is not redirected to the user interface 600C or to any other new user interface, but rather the player remains on the user interface 600B. In these embodiments, the buttons 610, 612, 614 may be disabled or removed from the user interface 600B. In some embodiments, the hold button 612 is not shown to the player, and if the player does not select the cash button 610 or the pool button 614, then it is assumed by default that the player wishes to hold their ticket.

In some embodiments, after the player selects the hold button 612, but before the third winning number is selected or the time period during which players can cash or pool their ticket, the player may be still be allowed to change their mind, and cash or pool their ticket. There may be a control available to the player on the user interface 600B, user interface 600C, or another user interface that is presented to the player allowing them to indicate that they no longer wish to hold their ticket, but instead cash or pool.

When the player does not make any selection (i.e., the player does not click on any one of the buttons 610, 612, or 614), the default may be holding of the ticket. Accordingly, when the player does select any one of the buttons 610, 612, or 614, it is assumed that the player wants to hold on to the ticket.

Upon the player selecting the cash button 610, a user interface 600D illustrated in FIG. 6D is shown to the player. The user interface 600D includes the message 616 providing the player with the winning amount of $20. The area 604 provides the two selected winning numbers and the player selected numbers. Once the final number is selected by the lottery, the area 604 may provide the third winning number to the player if the player is still viewing the FIG. 6D. In other embodiments, if the player leaves the user interface 600D, the full selection of winning numbers may be provided to the player in a different user interface so that the player can see if they would have won had they chosen not to cash out early.

The user interface 600D displays updated aggregate player activity data in the area 608. The player data is updated on an intermittent or period basis, such that the player is provided with up to date player activity information. For example, as shown, the number of cashed tickets went up to eighty tickets, while the number of pooled tickets went up to twenty tickets. If the player wishes to leave the user interface 600D, the winning numbers and/or updated player activity data may be still available to the player for viewing.

Upon selecting the pool button 614 in the user interface 600A, a user interface 600E shown in FIG. 6E is displayed to the player allowing him to join a pool. An area 618 shown in the user interface 600E indicates that there are a total of three pools, while an area 620 provides that there are eighty-six tickets that are eligible to join a pool (fourteen having already joined).

In some embodiments, the number of pools shown in the area 618 may be the total number of pools which the player is eligible to join. The pooling option is an alternative to the cashing option. In the lottery numbers game of this example, eligibility for cashing or pooling is determined solely by the outcome of the lottery's drawing of the first two numbers. Pooling is consequently available to all tickets that match the first two numbers drawn by the lottery. In other embodiments, the lottery engine may determine that the player is eligible to join a pool by application of other or additional quasi-random processes.

The stepwise social lottery game allowing players to pool selectively only those wagers that have a proven value may greatly increase the potential value of the pool, and make pooling a much more interesting and desirable option for players.

The number of tickets already in each of the pools is displayed in areas 622, 624, and 626. As shown, the first pool has 4 tickets, while the second pool has 3 tickets, and the third pool has 7 tickets. The player may request to view additional information associated with a pool by selecting (e.g., by clicking on, or tapping) one of the areas 622, 624, or 626. The additional pool information may include the selections made by each ticket in the pool, the maximum allowed tickets in the pool, the probability of winning with the current tickets already in the pool, etc. If a player has elected to allow for display of information that would serve to identify the player as the owner of a ticket in the pool, this ownership information may also be accessible to other players, further reinforcing the social aspect of play.

The player may choose to join one of the three pools using another user interface (not shown). Once the player joins the pool and the remaining winning number is selected, the proceeds that their tickets collectively win are equally split between the members of the pool.

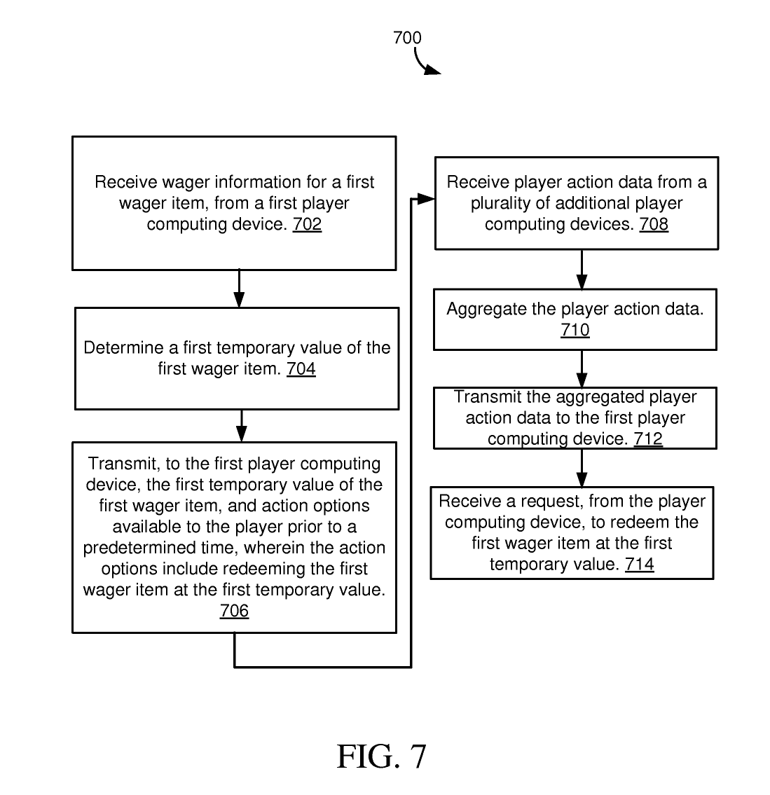

FIG. 7 is a flowchart of a process for providing a stepwise social lottery game that allows players to redeem their ticket at a temporary ticket value (e.g., before all the indicia such as numbers are selected by the lottery), while providing social data including aggregate player action information, in accordance with an illustrative embodiment. The process 700 can be implemented on a central server. For example, the stepwise social lottery management engine 102 can perform the steps of the process 700. In one embodiment, the process 700 is encoded on a computer-readable medium that contains instructions that, when executed by the central server, cause the central server to perform operations of the process 700.

At block 702 of the process 700, wager information for a first wager item is received, from a first player computing device. The wager information may include a plurality of player selected indicia (e.g., numbers). The total number of player selected indicia can be any number allowed by the lottery game. For example, as shown in FIG. 6A, the player is allowed to select three numbers from numbers between zero and nine. In another example, the player may be allowed to select five numbers.

A first set of indicia (e.g., numbers) may be selected, wherein one or more remaining indicia are to be selected at a predetermined time. In some embodiments, the indicia are numbers. In these embodiments, the number(s) in the first set of numbers may be selected randomly or pseudo-randomly from a set of available numbers. The first set of numbers and the one or more remaining numbers that are selected at a later time are the winning numbers of the stepwise social lottery game. Thus, some of the numbers are selected, with the remaining number(s) selected at a later time, allowing the player to take action with respect to their lottery ticket prior to the selection of the remaining numbers.

The first set of numbers may include one number, two numbers, or any other number of numbers. For example, in the example of the player having selected three numbers, a total of three winning numbers need to be selected. In this example, the first set of selected numbers may include two numbers, with the last number being selected at a predetermined time. Although not shown in the process 700, the predetermined time may be selected (e.g., randomly from a set of predetermined time periods) for each new lottery game.

A first temporary value of the first wager item is determined (block 704). In some embodiments, the first temporary value of the first wager item may be determined based on the plurality of player selected numbers and/or the first set of numbers. For instance, player selected numbers are compared to the first set of numbers, and the number of matches determine the first temporary value. In one example, if the player has selected three numbers, and the set of selected numbers includes two numbers, the first player selected number is compared to the first number in the set of selected numbers, and then the second player selected number is compared to the second number in the set of selected numbers. A predefined table may include winning amounts for every combination of matches between the player selected numbers and numbers selected by the lottery game. For example, the predefined table may provide that if the first player selected number matches the first number selected by the lottery game, then the payout amount is $5 (or any other amount pre-determined amount). In some embodiments, the first temporary value may be a value within a range between the minimum certain end value and the calculated share of the total prize liability associated with the ticket.

The first temporary value of the ticket, and action options available to the player prior to a predetermined period of time (e.g., the selection of the one or more remaining numbers) are transmitted (block 706) to the computing device. The action options include an option of redeeming the first wager item at the first temporary value. Other action options may include holding on to the ticket until the remaining number(s) are drawn, and pooling the ticket with other players' tickets. Other additional information may be transmitted to the player computing device including the period of time during which the first wager item can be redeemed for the first temporary value, the timing of the drawing of the remaining indicia (e.g., number(s)), the predefined table with the winning amounts, probability data including probability of winning based on the different combinations of selections by the player and winning numbers, etc. The first set of selected numbers may be transmitted to the computing device at the same or different time as the first temporary value of the ticket, and the action options available to the player.

Player action data is received (block 708) from a plurality of additional player computing devices. The player action data may include requests from the additional player computing devices to redeem, hold, or pool their wager items (e.g., tickets). Other players may transmit these requests during the time allowed for the players to take action. In some embodiments, a period of time may be determined during which the players may redeem or pool their wager items (e.g., this period of time may lapse prior to the drawing of the remaining number(s)). In other embodiments, the period of time may go up until the drawing of the remaining number(s).

At block 710 of the process 700, the received player action data is aggregated. Prior to aggregation, the received player action data may be stored along with other player data. During aggregation of data, total number of wager items that are redeemed, held, and pooled may be calculated. The resulting aggregated data may have no personally identifiable information of any of the individual players. Some players may not explicitly select any action (e.g., holding, cashing, or pooling), in which case the default action is holding the ticket, and those tickets will be counted as holding. In some embodiments, the data records associated with individual tickets may be initially stored as tickets that are held by the players, until players select to redeem or pool their ticket.

Some players may wish to opt out of being included in the aggregated player action data. A user interface may be provided allowing players to indicate that they would like to opt out of having their information being included in the aggregated player action data and shared with other players.

The aggregated player action data is transmitted (block 712) to the first player computing device, which in turn may display the aggregated player action data to the player. Thus, feedback about the choices made between the alternative offers is provided to players. Using the aggregated player action data, the first temporary value of the first wager item, and other information provided by the central engine, the player may determine their course of action.

The player action data may be received from various player computing devices as the players select actions with respect to their tickets. The aggregate data may be updated as player action data is received from the player computing devices, and then transmitted to the player computing device and other player computing devices, on an intermittent basis.

A request is received (block 714) from the player computing device to redeem the first wager item. The request is processed accordingly. In particular, the data associated with the player may be updated. The aggregate player action data may be updated with the player's request to redeem their wager item (i.e., the total number of redeemed wager items is incremented).

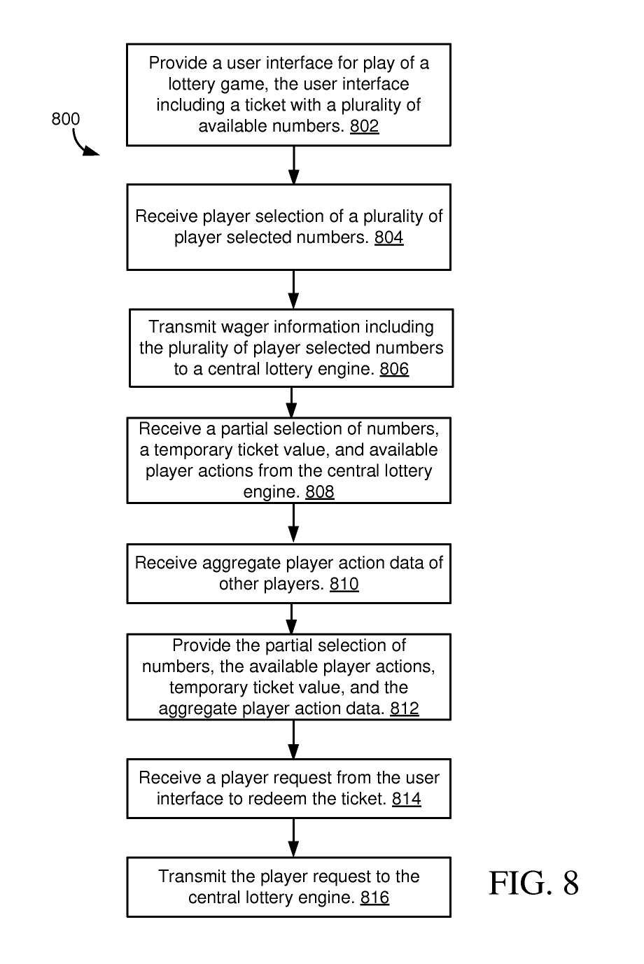

FIG. 8 is a flowchart of a client side process providing a stepwise social lottery game that allows players to redeem their ticket before all the numbers are selected by the lottery, while providing social data including aggregate player action information, in accordance with an illustrative embodiment. The process 800 can be implemented on a player computing device. For example, the player computing device 130, 140 or another player computing device can perform the steps of the process 800. In one embodiment, the process 800 is encoded on a computer-readable medium that contains instructions that, when executed by the computing device, cause the computing device to perform operations of the process 800.

A user interface is provided (block 802) (e.g., on a display of a player computing device) to the player for play of a lottery game. The user interface may include a ticket with a plurality of available numbers. Such exemplary user interface is illustrated in FIG. 6A, which displays three sets of numbers between 0 and 9. Using the user interface, the player may select allowed number of indicia (e.g., a number from each set of numbers from zero to nine as shown in FIG. 6A).

The player selection of a plurality of player selected numbers is received (block 804) from the user interface. The player may select the numbers from the plurality of available numbers (e.g., three sets of numbers between zero and nine, as shown in FIG. 6A). In some implementations, the player may be allowed to request that the numbers are automatically selected for the player (e.g., randomly).

Wager information including the plurality of player selected numbers is transmitted (block 806) to a central lottery engine. The central lottery engine may in turn record the wager information, and update its records.

A partial selection of numbers, a temporary ticket value, and available player actions are received (block 808) from the central lottery engine. The partial selection of numbers represent the winning numbers that were selected by the central lottery engine, with one or more remaining winning numbers being selected at a later time. The temporary ticket value may be calculated by the central engine based on the partial selection of numbers and the player selected numbers. The available player actions may include an option to redeem the ticket at the temporary ticket value, to hold the ticket until the remaining numbers are drawn, and to pool the ticket with other tickets. Other data received from the central engine may include probability data that specifies the probabilities of different possible ticket values of the ticket depending on the outcome of the selection of the remaining numbers.

Aggregate player action data of other players is received at block 810. The aggregate player action data may include up to date information about activities of other players during the lottery game. For example, the aggregate player action data may include a total number of purchased tickets, a total number of tickets held by the players, a total number of tickets cashed by the players at the temporary ticket values, and/or a total number of tickets pooled. The updated aggregate player action data may be received periodically or intermittently from the central server.

The partial selection of numbers, the available player actions, the temporary ticket value, and the aggregate player action data are provided (block 812) for display to the player. The aggregate player action data may be updated as the updates are received from the central server. Using this information, the player may make a decision to redeem their ticket. By providing to the player such information as how many other players have redeemed their tickets so far and the temporary ticket value, a more interesting and engaging environment is created for the player. The player is thus provided with the option to choose between prize offers (e.g., continue holding their ticket, or redeem it for the temporary value).

A player request to redeem the ticket at the temporary ticket value is received (block 814) from the user interface. Accordingly, the player has decided to redeem their ticket at the temporary ticket value prior to the selection of the remaining numbers. The player request to redeem the ticket is transmitted (block 816) to the central engine for further processing.

In some embodiments, even though the player has decided to redeem their ticket, updated aggregate data and remaining winning numbers may be displayed to the player. Using this data, the player may be able to determine if he made the right decision of redeeming their ticket early.

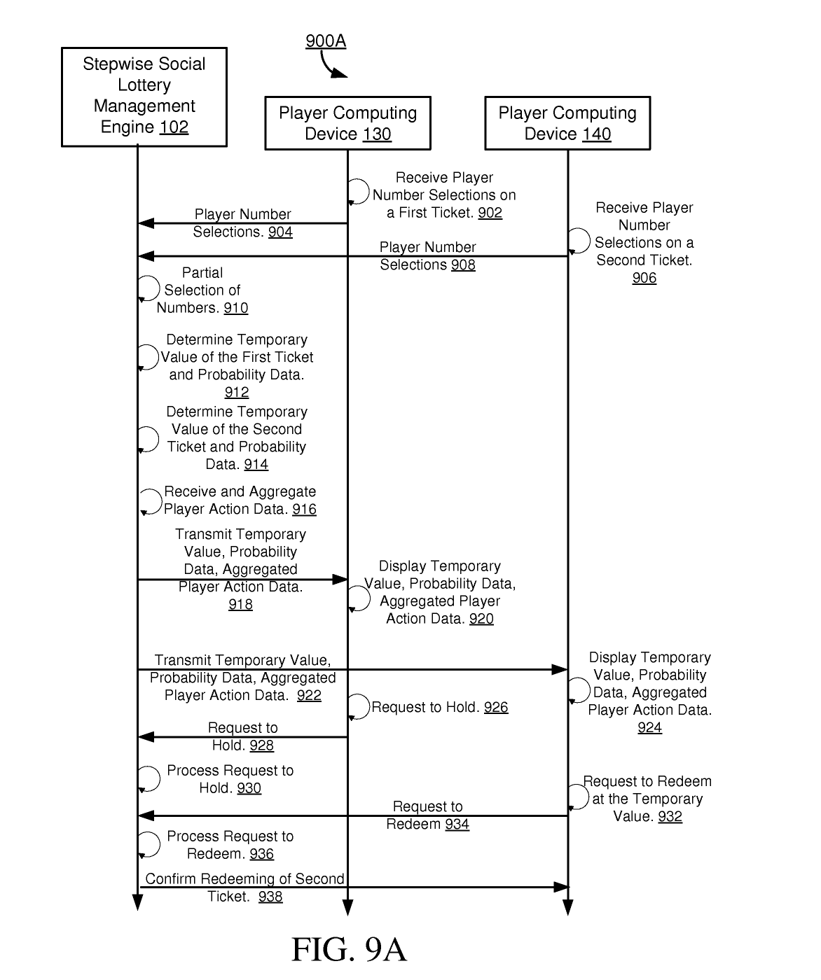

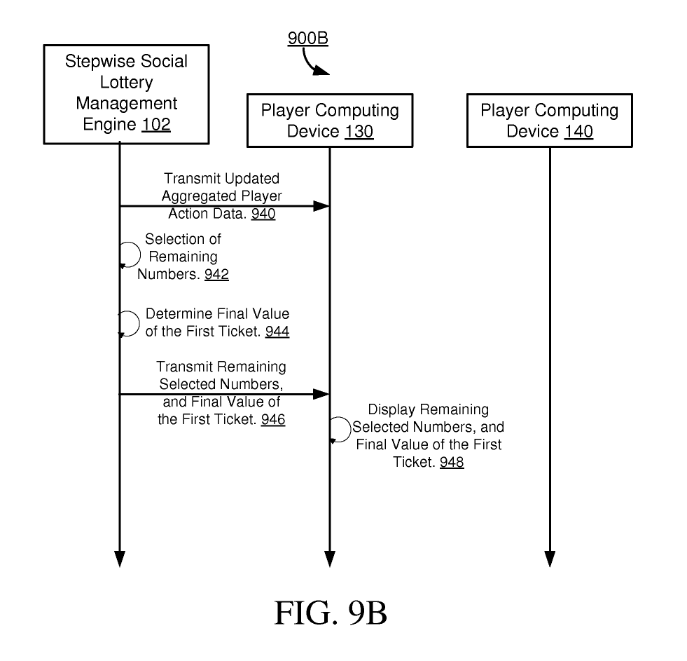

FIGS. 9A-9B illustrates flow diagrams between the stepwise social lottery management engine 102, and player computing devices 130 and 140, in accordance with an illustrative embodiment.

At block 902, upon a player selecting numbers on a user interface of a stepwise social lottery game provided by the player computing device 130, player number selections on a first ticket are received. The player number selections are then transmitted (block 904) to the stepwise social lottery management engine 102, which in turn may process the received data and store it.

A second player may utilize the player computing device 140 to play the same stepwise social lottery game as the player of the player computing device 130. The second player may then select numbers on a second ticket using a user interface provided by the player computing device 140. The player computing device 140 then receives (block 906) the player number selections on the second ticket, and transmits (block 908) the player selected numbers to the stepwise social lottery management engine 102, which in turn may process the received data and store it.

At block 910 of FIG. 9, the stepwise social lottery management engine 102 determines a partial selection of numbers from the available numbers. The partial selection of numbers means that not all the winning numbers are selected at this time. For example, if three winning numbers need to be selected during the lottery game, during step 910 of the process 900A, the stepwise social lottery management engine 102 may select two of the three winning numbers. In other words, a subset of all the winning numbers is selected, with the remaining numbers being selected by the stepwise social lottery management engine 102 at a later time (e.g., within a predetermined period of time, at a specific predetermined time, etc.).

The stepwise social lottery management engine 102 determines (block 912) temporary value of the first ticket and probability data for the first ticket. The temporary value of the first ticket may be determined based on matches between the partial selection of numbers and the player number selections by the first player. The determined probability data indicates what the probability is of each outcome, and of each possible winning amount.

The stepwise social lottery management engine 102 determines (block 914) temporary value of the second ticket and probability data for the second ticket. The temporary value of the second ticket may be determined based on matches between the partial selection of numbers and the player number selections by the second player. The determined probability data indicates what the probability is of each outcome, and of each possible winning amount.

Although not shown, the stepwise social lottery management engine 102 may determine temporary ticket values for other players playing the lottery game played by the players of the player computing device 130 and the player computing device 140.

The stepwise social lottery management engine 102 receives (block 916) player action data from a plurality of additional player computing devices (not shown), and aggregates the received player action data into aggregate player action data (e.g., data that does not have personally identifiable information of player or their computing devices). For example, if a player of another player computing device requests to redeem their ticket, the information regarding this player's action is transmitted to the stepwise social lottery management engine 102. Although receiving and aggregating of player action data is shown once in the FIG. 9A (in block 916), the stepwise social lottery management engine 102 receives player action data from various player computing devices participating in the lottery game at different times, as the requests to redeem, cash, or pool their tickets come from the respective player computing device. The stepwise social lottery management engine 102 updates its records including aggregates player action data as new player action data comes in.

The temporary ticket value, the probability data, and the aggregates player action data are transmitted (block 918) by the stepwise social lottery management engine 102 to the player computing device 130, and then displayed (block 920) to the player by the player computing device 130. Similarly, the temporary ticket value of the second ticket, the probability data associated with the second ticket, and the aggregate player action data are transmitted (block 922) by the stepwise social lottery management engine 102 to the player computing device 140, and then displayed (block 924) to the player by the player computing device 140. Accordingly, the players of the player computing devices 130 and 140 are provided with the same aggregate player action data, and with the temporary ticket values and probability value associated with their tickets. Although not shown, updates to the aggregate player action data are provided to the player computing devices 130 and 140 as they become available by the stepwise social lottery management engine 102.

In some embodiments, the temporary ticket value and/or probability information are transmitted by the stepwise social lottery management engine 102 prior to the processing of the player action data. Thus, the temporary ticket value and the probability data may be transmitted to the player computing device earlier than the aggregated player action data.

At block 926, the player of the player computing device 130 requests to hold their ticket (and not redeem it at this time). This request to hold is transmitted (block 928) to the stepwise social lottery management engine 102, which in turn processes (block 930) this request to hold by updating its records including aggregate player action data.

Unlike player of the player computing device 130, the player of the computing device 140 requests (block 932) to redeem the second ticket at the temporary value of the second ticket, which is then transmitted (block 934) to the stepwise social lottery management engine 102 for processing (block 936). The player may make this request to redeem their ticket using a lottery game user interface provided by the player computing device 140. The player of the player computing device 140 may have determined to redeem their ticket at the temporary ticket value based on the information provided by the stepwise social lottery management engine 102 including up to date aggregate player action data, the temporary ticket value of the second ticket, probability data associated with the second ticket, and/or other data. The stepwise social lottery management engine 102 may update the aggregate player data with the request to redeem received from the player of the player computing device 140. For example, the total number of redeemed tickets may be increased by one as a result of the player of the player computing device 140 redeeming their ticket prior to the selection of the remaining winning tickets. A confirmation (e.g., including confirmation number, total winning amount, etc.) of the redemption of the second ticket may be transmitted (block 938) to player computing device 140.

As further shown in FIG. 9B, updated aggregated player action data is transmitted (block 940) to the player computing device 130, which may include action data of the player of the computing device 140 redeeming the second ticket, as well as actions of other players. Although the player of the player computing device 140 decided to redeem their ticket, updated aggregated player action data may also be transmitted to the player computing device 140 for display to the player.

At block 942, the stepwise social lottery management engine 102 selects (e.g., randomly or pseudo-randomly from the available numbers) the remaining winning number(s). In the example provided above of two numbers (out of three) being selected at block 910, one remaining winning number is selected at block 942.

The final value of the first ticket is determined (block 944) based on the player selected numbers and the numbers selected in block 910 and block 942, which are the winning numbers of the lottery game. As a result, the first ticket value may increase or decrease depending on the final selection of the remaining numbers. The remaining selected numbers and the final value of the first ticket are transmitted (block 946), and then displayed (block 948) to the player of the player computing device 140. Although not shown, the selected remaining number(s) may be transmitted to the player computing device 140 for display to the second player.

The two embodiments illustrated in the figures (i.e., the first embodiment illustrated in FIGS. 2A-2G, 3, 4, 5A-5B, and the second embodiment illustrated in FIGS. 6A-E, 7, 8, 9A-9B) are provided for illustrative purposes only, and it should be understood that the stepwise social lottery game providing stepwise procedure of selecting winning values and distributing up to date player action data may be applied in other types of games, as will be apparent to one skilled in the art.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, but not limited to, a combination of a DSP and a microprocessor, a plurality of microprocessors, one or more microprocessors in conjunction with a DSP core, or any other such configuration.

The steps of a method or process described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The above description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component such as the engine 102, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

At least some of the features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to play the stepwise social lottery game. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple such software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or central engines; (b) one or more electronic gaming machines (EGMs); and/or (c) one or more personal gaming devices, such as desktop computers, laptop computers, tablet computers or computing devices, personal digital assistants (PDAs), mobile telephones such as smart phones, and other mobile computing devices.

Thus, in various embodiments, the gaming system of the present disclosure includes: (a) one or more player computing devices in combination with one or more central servers, central controllers, or central engines; (b) one or more personal gaming devices in combination with one or more central servers, central controllers, or central engines; (c) one or more personal gaming devices in combination with one or more EGMs; (d) one or more personal gaming devices, one or more EGMs, and one or more central servers, central controllers, or central engines in combination with one another; (e) a single EGM; (f) a plurality of EGMs in combination with one another; (g) a single personal gaming device; (h) a plurality of personal gaming devices in combination with one another; (i) a single central server, central controller, or central engine; and/or (j) a plurality of central servers, central controllers, or central engines in combination with one another.

The “central server”, “central engine”, “central controller” as used herein may represents one central server, central controller, or central engine or a plurality of central servers, central controllers, or central engines.

In various embodiments, the gaming system includes one or more player computing devices in combination with a central server, central controller, or central engine. In such embodiments, the player computing devices are configured to communicate with the central server, central controller, or central engine through a data network or remote communication link. In certain such embodiments, the player computing device is configured to communicate with another player computing device through the same data network or remote communication link or through a different data network or remote communication link. For example, a gaming system may include a plurality of player computing devices that are each configured to communicate with a central server, central controller, or a central engine through a data network.

In certain embodiments in which the gaming system includes a player computing device in combination with a central server, central controller, or central engine, the central server, central controller, or central engine is any suitable computing device (such as a server) that includes at least one processor and at least one memory device or storage device. The player computing device may include at least one processor configured to transmit and receive data or signals representing events, messages, commands, or any other suitable information between the player computing device and the central server, central controller, or central engine. The at least one processor of that player computing device is configured to execute the events, messages, or commands represented by such data or signals in conjunction with the operation of the player computing device. Moreover, the at least one processor of the central server, central controller, or central engine is configured to transmit and receive data or signals representing events, messages, commands, or any other suitable information between the central server, central controller, or central engine and the player computing device. The at least one processor of the central server, central controller, or central engine is configured to execute the events, messages, or commands represented by such data or signals in conjunction with the operation of the central server, central controller, or central engine. It should be appreciated that one, more, or each of the functions of the central server, central controller, or central engine may be performed by the at least one processor of the player computing device. It should be further appreciated that one, more, or each of the functions of the at least one processor of the player computing device may be performed by the at least one processor of the central server, central controller, or central engine.

In certain such embodiments, computerized instructions for controlling any games (e.g., stepwise social lottery games) displayed by the player computing device are executed by the central server, central controller, or central engine. In such “thin client” embodiments, the central server, central controller, or central engine remotely controls the lottery games (or other suitable interfaces) displayed by the player computing device, and the player computing device is utilized to display such games (or suitable interfaces) and to receive one or more inputs or commands. In other such embodiments, computerized instructions for controlling any games displayed by the player computing device are communicated from the central server, central controller, or central engine to the player computing device and are stored in at least one memory device of the player computing device. In such “thick client” embodiments, the at least one processor of the player computing device executes the computerized instructions to control any games (or other suitable interfaces) displayed by the player computing device.

In various embodiments in which the gaming system includes a plurality of player computing devices, one or more of the player computing devices are thin client player computing devices and one or more of the player computing devices are thick client player computing devices. In other embodiments in which the gaming system includes one or more player computing devices, certain functions of one or more of the player computing devices are implemented in a thin client environment, and certain other functions of one or more of the player computing devices are implemented in a thick client environment. In one such embodiment in which the gaming system includes an player computing device and a central server, central controller, or central engine, computerized instructions for controlling any primary or base games displayed by the player computing device are communicated from the central server, central controller, or central engine to the player computing device in a thick client configuration, and computerized instructions for controlling any secondary or bonus games or other functions displayed by the player computing device are executed by the central server, central controller, or central engine in a thin client configuration.

In certain embodiments in which the gaming system includes: (a) a player computing device configured to communicate with a central server, central controller, or central engine through a data network; and/or (b) a plurality of player computing devices configured to communicate with one another through a data network, the data network is a local area network (LAN) in which the player computing devices are located substantially proximate to one another and/or the central server, central controller, or central engine. In one example, the player computing devices and the central server, central controller, or central engine are located in a gaming establishment or a portion of a gaming establishment (controlled by a government lottery organization or a casino establishment).

In other embodiments in which the gaming system includes: (a) a player computing device configured to communicate with a central server, central controller, or central engine through a data network; and/or (b) a plurality of player computing devices configured to communicate with one another through a data network, the data network is a wide area network (WAN) in which one or more of the player computing devices are not necessarily located substantially proximate to another one of the player computing devices and/or the central server, central controller, or central engine. For example, one or more of the player computing devices are located: (a) in an area of a gaming establishment different from an area of the gaming establishment in which the central server, central controller, or central engine is located; or (b) in a gaming establishment different from the gaming establishment in which the central server, central controller, or central engine is located. In another example, the central server, central controller, or central engine is not located within a gaming establishment in which the player computing devices are located. It should be appreciated that in certain embodiments in which the data network is a WAN, the gaming system includes a central server, central controller, or central engine and a player computing device each located in a different gaming establishment in a same geographic area, such as a same city or a same state. It should be appreciated that gaming systems in which the data network is a WAN are substantially identical to gaming systems in which the data network is a LAN, though the quantity of player computing devices in such gaming systems may vary relative to one another.

In further embodiments in which the gaming system includes: (a) a player computing device configured to communicate with a central server, central controller, or central engine through a data network; and/or (b) a plurality of player computing devices configured to communicate with one another through a data network, the data network is an internet or an intranet. In certain such embodiments, an Internet browser of the player computing device is usable to access an internet game page from any location where an internet connection is available. In one such embodiment, after the internet game page is accessed, the central server, central controller, or central engine identifies a player prior to enabling that player to place any wagers on any plays of any wagering games (e.g., the stepwise social lottery game). In one example, the central server, central controller, or central engine identifies the player by requiring a player account of the player to be logged into via an input of a unique username and password combination assigned to the player. It should be appreciated, however, that the central server, central controller, or central engine may identify the player in any other suitable manner, such as by validating a player tracking identification number associated with the player; by reading a player tracking card or other smart card inserted into a card reader (as described below); by validating a unique player identification number associated with the player by the central server, central controller, or central engine; or by identifying the player computing device, such as by identifying the MAC address or the IP address of the internet facilitator. In various embodiments, once the central server, central controller, or central engine identifies the player, the central server, central controller, or central engine enables placement of one or more wagers on one or more plays of one or more games (e.g., stepwise social lottery games), and displays those plays via the internet browser of the player computing device.

It should be appreciated that the central server, central controller, or central engine and the player computing device are configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections increases opportunities for players to use a variety of player computing devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In various embodiments, a player computing device includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs).

As generally noted above, the at least one processor of the player computing device is configured to communicate with, configured to access, and configured to exchange signals with at least one memory device or data storage device. In various embodiments, the at least one memory device of the player computing device includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the player computing device includes flash memory and/or EEPROM (electrically erasable programmable read only memory). It should be appreciated that any other suitable magnetic, optical, and/or semiconductor memory may operate in conjunction with the player computing device disclosed herein. In certain embodiments, the at least one processor of the player computing device that is an EGM and the at least one memory device of the player computing device both reside within a cabinet of the player computing device. In other embodiments, at least one of the at least one processor of the EGM player computing device and the at least one memory device of the player computing device reside outside the cabinet of the player computing device.

In certain embodiments, as generally described above, the at least one memory device of the player computing device stores program code and instructions executable by the at least one processor of the player computing device to control the player computing device. The at least one memory device of the player computing device also stores other operating data, such as image data, event data, input data, random number generators (RNGs) or pseudo-RNGs, paytable data or information, and/or applicable game rules that relate to the play of one or more games on the player computing device (such as the stepwise social lottery games as described below). In various embodiments, part or all of the program code and/or the operating data described above is stored in at least one detachable or removable memory device including, but not limited to, a cartridge, a disk, a CD-ROM, a DVD, a USB memory device, or any other suitable non-transitory computer readable medium. In certain such embodiments, an operator (such as a gaming establishment operator) and/or a player uses such a removable memory device in n player computing device to implement at least part of the present disclosure. In other embodiments, part or all of the program code and/or the operating data is downloaded to the at least one memory device of the player computing device through any suitable data network described above (such as an internet or intranet).

In various embodiments, the player computing device includes one or more input devices. The input devices may include any suitable device that enables an input signal to be produced and received by the at least one processor of the player computing device. In the example when the player computing device is an EGM, one input device of the player computing device may a payment device configured to communicate with the at least one processor of the player computing device to fund the player computing device. In certain embodiments, the payment device includes one or more of: (a) a bill acceptor into which paper money is inserted to fund the player computing device; (b) a ticket acceptor into which a ticket or a voucher is inserted to fund the player computing device; (c) a coin slot into which coins or tokens are inserted to fund the player computing device; (d) a reader or a validator for credit cards, debit cards, or credit slips into which a credit card, debit card, or credit slip is inserted to fund the player computing device; (e) a player identification card reader into which a player identification card is inserted to fund the player computing device; or (f) any suitable combination thereof.

In one embodiment, the player computing device that is an EGM includes a payment device configured to enable the EGM to be funded via an electronic funds transfer, such as a transfer of funds from a bank account. In another embodiment, the EGM player computing device includes a payment device configured to communicate with a mobile device of a player, such as a cell phone, a radio frequency identification tag, or any other suitable wired or wireless device, to retrieve relevant information associated with that player to fund the EGM player computing device. It should be appreciated that when the EGM player computing device is funded, the at least one processor determines the amount of funds entered and displays the corresponding amount on a credit display or any other suitable display as described below.

In certain embodiments, one input device of the player computing device is a touch-screen coupled to a touch-screen controller or other touch-sensitive display overlay to enable interaction with any images displayed on a display device. One such input device is a conventional touch-screen button panel. The touch-screen and the touch-screen controller are connected to a video controller. In these embodiments, signals are inputted to the player computing device by touching the touch screen at the appropriate locations.

In various embodiments, one input device of the player computing device is a sensor, such as a camera, in communication with the at least one processor of the player computing device (and controlled by the at least one processor of the player computing device in some embodiments) and configured to acquire an image or a video of a player using the player computing device and/or an image or a video of an area surrounding the player computing device.

In various embodiments, the player computing device includes one or more output devices (e.g., display). One or more output devices of the player computing device are one or more display devices configured to display any stepwise social lottery game(s) displayed by the player computing device and any suitable information associated with such game(s).

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, the display device includes a touch-screen with an associated touch-screen controller. It should be appreciated that the display devices may be of any suitable sizes, shapes, and configurations.

The display devices of the player computing device are configured to display one or more game and/or non-game images, symbols, and indicia. In certain embodiments, the display devices of the player computing device are configured to display any suitable visual representation or exhibition of the movement of objects; numbers; dynamic lighting; video images; images of things; and the like.

In various embodiments, one output device of the player computing device is a payout device. In these embodiments, when the cash out device is utilized, the payout device causes a payout to be provided to the player. In one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. In one embodiment, the player computing device includes a payout device configured to fund an electronically recordable identification card or smart card or a bank account via an electronic funds transfer.

In certain embodiments, one output device of the player computing device is a sound generating device controlled by one or more sound cards. In one such embodiment, the sound generating device includes one or more speakers or other sound generating hardware and/or software for generating sounds. In another such embodiment, the player computing device provides dynamic sounds coupled with attractive multimedia images displayed on one or more of the display devices to provide an audiovisual representation or to otherwise display full-motion video with sound to attract players to play the stepwise social lottery game.

In various embodiments, the player computing device may include a plurality of communication ports configured to enable the at least one processor of the player computing device to communicate with and to operate with external peripherals (e.g., display screens or other displays or video sources, expansion buses, information panels, keypads, microphones, motion sensors, printers, speakers, thumb sticks, touch screens, touchpads, and wireless communication devices.

Player computing devices may include electronic gaming machines and personal gaming devices, and it should be appreciated that certain of the example player computing devices described above include certain elements that may not be included in all player computing devices. For example, the payment device of a personal gaming device such as a mobile telephone may not include a coin acceptor, while in certain instances the payment device of an EGM located in a gaming establishment may include a coin acceptor.

As generally explained above, in various embodiments in which the gaming system includes a central server, central controller, or central engine and a one or more player computing devices, the at least one memory device of the central server, central controller, or central engine stores different game programs and instructions executable by the at least one processor of the player computing devices to control the stepwise social games displayed by the player computing device. More specifically, each such executable game program represents a different game or a different type of game.

In operation of such embodiments, the central server, central controller, or central engine may be configured to communicate one or more of the stored executable game programs to the at least one processor of the player computing device. In different embodiments, a stored executable game program is communicated or delivered to the at least one processor of the changeable player computing device by: (a) writing the executable game program onto a disc or other media; (b) uploading or streaming the executable game program over a data network (such as a dedicated data network), or another method. After the executable game program is communicated from the central server, central controller, or central engine to the player computing device, the at least one processor of the player computing device may executes the executable game program to enable the primary game and/or the secondary game associated with that executable game program to be played using the display device(s) and/or the input device(s) of the player computing device. That is, when an executable game program is communicated to the at least one processor of the player computing device, the at least one processor of the player computing device changes the game or the type of game that may be played using the player computing device.

In some embodiments, the central engine or system may randomly determine game outcome(s) (such as a win outcome) and/or award(s) for play of a stepwise (e.g., based on probability data). In such embodiments, this random determination may be provided through utilization of a random number generator (“RNG”), such as a true RNG or a pseudo RNG, or any other suitable randomization process. In one such embodiment, each game outcome or award is associated with a probability, and the central engine generates the game outcome(s) and/or the award(s) to be provided based on the associated probabilities.

As noted above, in various embodiments, the gaming system includes one or more executable game programs executable by at least one processor of the gaming system to provide one or more stepwise social games. In various embodiments, the stepwise social lottery games may comprise any suitable games and/or wagering games, such as, but not limited to: stepwise lottery game allowing for purchasing of pseudo stocks and dissemination of player action data that allows players to redeem their pseudo stocks prior to the next price changes of the pseudo stocks; stepwise lottery game resembling a numbers lottery game that allows for dissemination of player action data and stepwise determination of ticket values; and others.

In various embodiments in which the gaming system includes a plurality of player computing devices, the player computing devices may be configured to communicate with one another (e.g., via a network, via the central engine, etc.) to provide a group gaming environment. In some embodiments, the player may pool their tickets together enabling the players to play together as a team to win more awards.

What is claimed is:

1. A method comprising:
receiving, over a network, wager information for a first plurality of wager items, from a plurality of player computing devices, each wager item having a first predetermined price;
determining, using a processor, a multiplier from a set of multipliers at a predetermined time;
updating, using the processor, value of each wager item by applying the multiplier to the first predetermined price;
transmitting, over the network, updated value of each wager item to the plurality of player computing devices;
receiving player action data, from at least some of the plurality of player computing devices;
aggregating, using the processor, the player action data; and
transmitting the aggregate player action data to the plurality of player computing devices.

2. The method of claim 1, further comprising receiving, over the network, a request to redeem a first wager item at the updated value from a first player computing device.

3. The method of claim 2, further comprising updating the aggregate player action data with the request to redeem the first wager item.

4. The method of claim 3, further comprising transmitting the updated aggregate player action data to the plurality of player computing devices.

5. The method of claim 1, wherein the aggregate player action data includes any combination of: a total number of redeemed wager items, a total number of purchased wager items, and a total number of held wager items.

6. The method of claim 1, further comprising:
determining, using the processor, a second multiplier from the set of multipliers at a second predetermined time;
updating, using the processor, value of each wager item by applying the second multiplier to the updated price producing a second updated value; and
transmitting, over the network, the second updated value of each wager item to the plurality of player computing devices.

7. The method of claim 6, further comprising receiving one or more requests to redeem one or more wager items at the second updated value.

8. An electronic device configured to allow a player to play a lottery game, comprising:
a display configured to display the lottery game to the player;
a user-input device; and
one or more data processors and one or more storage devices storing instructions that, when executed by the one or more data processors, cause the one or more data processors to perform operations comprising:
receiving, over a network, from a lottery gaming server, information regarding a plurality of wager item types, including a predetermined price for each wager item;
displaying in a user interface provided on the display received information regarding the plurality of wager item types;
receiving, from the user interface, a request to purchase a wager item of a first wager item type at the predetermined price;
transmitting, over the network, to the lottery gaming server, a request to purchase a wager item of a first wager item type at the predetermined price;
receiving, over the network, from the lottery gaming server, a first updated price for the wager item and a first price validity period;
displaying the first updated price and the first price validity period for the wager item, wherein the player is allowed to redeem the wager item at the first updated price during the validity period;
receiving, over the network, from the lottery gaming server, player activity data including a total number of redeemed wager items by a plurality of players at the first updated price;
displaying the received player activity data;
receiving, over the network, from the lottery gaming server, a second updated price for the wager item and a second price validity period;
displaying the second updated price for the wager item and the second price validity period;
receiving, over the network, from the lottery gaming server, updated player activity data including a total number of redeemed wager items at the first updated price and a total number of redeemed wager items at the second updated price; and
displaying the updated player activity data.

9. The electronic device of claim 8, wherein player activity data further including a total number of purchased wager items.

10. The electronic device of claim 8, wherein player activity data further including a total number of pooled wager items.

11. The electronic device of claim 8, wherein the operations further comprising:
receiving a request to redeem the wager item at the second updated price; and
transmitting the request to the lottery gaming server.

12. The electronic device of claim 8, wherein the first updated value is a result of application of a first selected multiplier to the predetermined price.

13. The electronic device of claim 12, wherein the second updated value is a result of application of a second selected multiplier to the first updated price.

14. The electronic device of claim 12, wherein the operations further comprising receiving, over the network, from the lottery gaming server, a plurality of actions available to the player during the first validity period, the plurality of actions including redeeming the wager item, holding the wager item, and pooling the wager item with one or other wager items.

15. A system comprising:
one or more data processors; and
one or more storage devices storing instructions that, when executed by the one or more data processors, cause the one or more data processors to perform operations comprising:
receiving wager information for a first wager item, from a first player computing device;
determining a first temporary value of the first wager item;
transmitting, to the first player computing device, the first temporary value of the first wager item, and action options available to the player prior to a predetermined period of time;
receiving player action data from a plurality of additional player computing devices;
aggregating the player action data;
transmitting the aggregated player action data to the first player computing device; and
receiving a request, from the player computing device, to redeem the first wager item at the first temporary value.

16. The system of claim 15, further comprising selecting a first set of indicia, wherein one or more remaining indicia are to be selected at a predetermined time; and transmitting, to the first player computing device, the first set of selected indicia.

17. The system of claim 15, wherein the action options include redeeming the ticket at the first temporary value.

18. The system of claim 15, wherein the action options include pooling the wager item with one or more eligible other wager items associated with other players.

19. The system of claim 15, where the action options including holding the wager item until the selection of the remaining numbers at the predetermined time.

20. The system of claim 15, the operations further comprising updating the aggregated player data with the request to redeem the first wager item at the first temporary value.
